(19) United States
(12) Patent Application Publication
(10) Pub. No.: US 2024/0305331 A1
(43) Pub. Date: Sep. 12, 2024

(54) TRANSMITTER, RECEIVER, AND TRANSCEIVER INCLUDING TRANSMITTER AND RECEIVER

(71) Applicant: Samsung Electronics Co., Ltd., Suwon-si (KR)

(72) Inventors: Hyun Jun PARK, Seoul (KR); Woo-Seok CHOI, Seoul (KR)

(73) Assignees: Samsung Electronics Co., Ltd., Suwon-si (KR); UIF (University Industry Foundation), Yonsei University, Seoul (KR)

(21) Appl. No.: 18/581,635

(22) Filed: Feb. 20, 2024

(30) Foreign Application Priority Data
Mar. 7, 2023 (KR) 10-2023-0030146
Jul. 18, 2023 (KR) 10-2023-0093123

(51) Int. Cl. H04B 3/32; H04L 25/08; H04L 25/49

(52) U.S. Cl. CPC H04B 3/32; H04L 25/085; H04L 25/4923

(57) ABSTRACT

A communication system includes a transmitter that encodes binary bits of each of a plurality of data streams into a plurality of symbols and converts the plurality of symbols into a plurality of output signals, respectively corresponding to a plurality of channels, the converting based on a transmission rule defined by a first matrix; and a receiver that combines the plurality of output signals, received through the plurality of channels, the combining based on a reception rule defined by a second matrix, the combining restoring the plurality of symbols, and the receiver decodes the plurality of symbols into the binary bits. The first matrix and the second matrix are determined based on a third matrix that models a crosstalk effect between adjacent channels from among the plurality of channels, to reduce the crosstalk effect.

### CROSS-REFERENCE TO RELATED APPLICATION(S)

This U.S. non-provisional application claims priority under 35 USC § 119 to Korean Patent Application No. 10-2023-0030146, filed on Mar. 7, 2023 and Korean Patent Application No. 10-2023-0093123, filed on Jul. 18, 2023, in the Korean Intellectual Property Office, the disclosures each of which are herein incorporated by reference in their entirety.

### BACKGROUND

The present disclosure relates to a communication system, a transmitter, and a receiver transmitting information in a device or between devices.

Single-ended signaling is a method of transmitting data through a plurality of channels in a communication system. However, the single-ended signaling may suffer from simultaneous switching noise (SSN), caused by an inductance component present in a wire of each channel, and crosstalk caused by a signal applied to an adjacent wire.

Differential signaling may be used to prevent SSN, but the use of differential signaling requires more pins than single-ended signaling, resulting in reduced pin efficiency, crosstalk between channels is still problematic with differential signaling.

Accordingly, there is a need for a communication system for increasing pin efficiency while maintaining the advantages of differential signaling and reducing (and/or minimizing crosstalk between a plurality of channels.

### SUMMARY

Example embodiments provide a communication system which may reduce (and/or minimize) crosstalk between adjacent channels, reduce (and/or eliminate) simultaneous switching noise (SSN), and achieve a higher data transmission rate when data is transmitted and received using a plurality of channels.

Example embodiments of the inventive concepts provide a communication system that includes a transmitter that encodes binary bits of each of a plurality of data streams into a plurality of symbols and converts the plurality of symbols into a plurality of output signals, respectively corresponding to a plurality of channels, the converting based on a transmission rule that is defined by a first matrix; and a receiver that combines the plurality of output signals, received through the plurality of channels, the combining based on a reception rule defined by a second matrix, the combining restoring the plurality of symbols, and the receiver decodes the plurality of symbols into the binary bits. The first matrix and the second matrix are determined based on a third matrix that models a crosstalk effect between adjacent channels from among the plurality of channels, to reduce the crosstalk effect.

When the number of the plurality of data streams is m and the number of the plurality of channels is n, the first matrix and the second matrix are determined based on the following equation,

$$arg {min}_{T , R} max ( abs ( ( {R}_{eff} \cdot C \cdot {T}_{eff} - diag ( {R}_{eff} \cdot C \cdot {T}_{eff} ) ) \times [ \begin{matrix}1 \\ ⋮ \\ 1\end{matrix} ] ) )$$

where T_{eff} is

$$diag ( \frac{1}{{t}_{1}} , \frac{1}{{t}_{2}} , … , \frac{1}{{t}_{n}} ) \cdot T ,$$

R_{eff} is diag(g₁, g₂, . . . , gₘ)·R, T is the first matrix, R is the second matrix, C is the third matrix obtained by modeling the crosstalk effect between the plurality of channels, and tᵢ is an L1 norm of an i-th row vector of T.

A product matrix of R_{eff} and T_{eff} may be an m-order equivalent matrix, T may be an n×m integer matrix, a sum of elements of a column vector of T may be 0, the L1 norm of a row vector of T may be less than or equal to a threshold value, and R may be an m×n integer matrix.

Row vectors of the first matrix may correspond to the plurality of channels, respectively. Each of the plurality of output signals may have a voltage level based on an inner product of a row vector corresponding to a channel from among the row vectors of the first matrix, and a column vector including the plurality of symbols.

The transmitter may include a plurality of driver groups that perform an operation corresponding to the inner product, for each of the plurality of channels. A number of drivers, included in each of the plurality of driver groups, may be determined based on elements of a row vector corresponding to a channel from among the row vectors of the first matrix.

The transmitter may include a plurality of encoders, respectively corresponding to the plurality of driver groups. Each of the plurality of encoders may generate control signals for controlling at least one driver, included in a corresponding driver group, based on binary bits of an input data stream. Each of the at least one driver, included in the corresponding driver group, may generate a symbol level of a symbol corresponding to the binary bits of the input data stream based on the control signals. A data stream, input to each of the plurality of encoders, may be determined based on elements of a row vector corresponding to a channel among the row vectors of the first matrix.

Each of the plurality of encoders may generate the control signals based on an encoding rule defined to reduce (and/or minimize) decoding errors caused by additive white Gaussian noise (AWGN).

A driver, included in each of the plurality of driver groups, may be a pulse amplitude modulation three level (PAM-3) driver, and the PAM-3 driver may generate a ternary symbol of 2 unit intervals (UI) corresponding to three binary bits based on the control signals.

The ternary symbol of 2UI may include a first symbol level of a first UI and a second symbol level of a second UI. Each of the first and second symbol levels may be a single level, among a low level (L), a middle level (M), and a high level (H). The encoding rule, expressed as a constellation diagram in which a horizontal axis is the first symbol level and a vertical axis is the second symbol level, may satisfy the following first and second conditions:
the first condition: eight combinations of three binary bits are mapped to eight points, other than a point at which both the first symbol level and the second symbol level are middle levels, among nine points in the constellation diagram; and
the second condition: a Hamming distance between combinations mapped to adjacent points of the constellation diagram, among the eight combinations mapped based on the first condition, is 1.

A voltage level of each of the plurality of output signals may have a value normalized between a driving voltage of a driver, included in each of the plurality of driver groups, and a ground voltage.

The transmitter may include a serializer that converts each of the plurality of data streams into three binary bit streams, and a predriver that generates differential signals for each of the three converted binary bit streams. Each of the differential signals may be provided to a corresponding driver group based on elements of the first matrix.

A sum of voltage levels of the plurality of output signals may remain constant over time.

Row vectors of the second matrix may correspond to the plurality of symbols, respectively. Each of the plurality of symbols may be restored based on an inner product of a row vector corresponding to a symbol from among the row vectors of the second matrix, and a column vector including the received plurality of output signals.

The receiver may include a combiner, that combines at least a portion of the plurality of received output signals and performs an operation corresponding to the inner product, for each of the plurality of symbols. An output signal, input to the combiner, may be determined based on elements of a row vector corresponding to a symbol from among the row vectors of the second matrix.

The receiver may include a sampler and a decoder corresponding to the combiner. The sampler may generate a plurality of sampling signals based on a symbol level of a symbol restored in the combiner, and the decoder may obtain binary bits, corresponding to the restored symbol, based on the plurality of sampling signals.

The transmitter may encode binary bits into a symbol based on an encoding rule defined to reduce (and/or minimize) error bits caused by AWGN, and the decoder may obtain binary bits, corresponding to the restored symbol, based on an inverse rule of the encoding rule.

Each of the plurality of symbols may be a ternary symbol of 2 unit intervals (UI). The sampler may generate the plurality of sampling signals based on symbol levels of a ternary symbol of 2UI restored in the combiner, and the decoder may obtain three binary bits corresponding to the ternary symbol of 2UI based on the plurality of sampling signals.

The transmitter and the receiver may be included in a single transceiver.

Example embodiments of the inventive concepts further provide a transmitter including a plurality of encoders that each generate control signals for converting binary data of input data streams from among n data streams into symbol data; and a plurality of drivers that generate the symbol data based on the control signals, the plurality of drivers transmit an output signal based on the generated symbol data through n+1 channels, based on a transmission rule defined by an encoding matrix. The encoding matrix may be an (n+1)×n-dimensional matrix determined based on a matrix that models a crosstalk effect between adjacent channels of the n+1 channels, to reduce the crosstalk effect. Each of the plurality of encoders may generate the control signals based on an encoding rule defined to reduce decoding errors caused by additive white Gaussian noise (AWGN).

Example embodiments of the inventive concepts still further provide a receiver that includes a plurality of combiners that combine n+1 output signals received through n+1 channels, and the plurality of combiners restore n symbols from the combined n+1 output signals; and a plurality of decoders that obtain n+1 pieces of binary data based on the restored n symbols. The decoding matrix may be an n×(n+1)-dimensional matrix determined based on a matrix that models a crosstalk effect between adjacent channels of the n+1 channels, to reduce crosstalk. Each of the plurality of decoders obtains the binary data based on an inverse rule of an encoding rule defined to reduce decoding errors caused by additive white Gaussian noise (AWGN).

### BRIEF DESCRIPTION OF DRAWINGS

The above and other aspects, features, and advantages of the present disclosure will be more clearly understood from the following detailed description, taken in conjunction with the accompanying drawings.

FIG. 1A is a block diagram of a communication system according to some example embodiments.

FIG. 1B is a block diagram of a communication system according to some example embodiments.

FIG. 2A is a diagram illustrating a plurality of channels according to some example embodiments.

FIG. 2B is a diagram illustrating a signaling model of a communication system according to some example embodiments.

FIG. 3 is a block diagram illustrating an example of how to implement a communication system according to some example embodiments.

FIG. 4 is a diagram illustrating an example of a configuration of a transmitter according to some example embodiments.

FIG. 5A is a diagram illustrating an example of a detailed configuration of a PAM-3 driver according to some example embodiments.

FIG. 5B is a diagram illustrating an operation of the PAM-3 driver of FIG. 5A.

FIG. 6 is a diagram illustrating an encoding rule according to some example embodiments.

FIG. 7A is a diagram illustrating an example of a configuration of a transmitter generating an output signal according to some example embodiments.

FIG. 7B is a diagram illustrating an example of a configuration of a transmitter generating an output signal according to some example embodiments.

FIG. 7C is a diagram illustrating an example of a configuration of a transmitter generating an output signal according to some example embodiments.

FIG. 7D is a diagram illustrating an example of a configuration of a transmitter generating an output signal according to some example embodiments.

FIG. 8A is a diagram illustrating an example of a configuration of a combiner according to some example embodiments.

FIG. 8B is a diagram illustrating an example of a configuration of a combiner according to some example embodiments.

FIG. 8C is a diagram illustrating an example of a configuration of a combiner according to some example embodiments.

FIG. 8D is a diagram illustrating an example of a configuration of a combiner according to some example embodiments.

FIG. 9 is an diagram illustrating the configuration of a receiver according to some example embodiments.

FIG. 10 is a conceptual diagram of a communication system according to some example embodiments.

FIG. 11 is a diagram illustrating an example of how to implement a serializer and a predriver according to some example embodiments.

FIG. 12 is a diagram illustrating an encoding rule according to some example embodiments.

FIG. 13 is a block diagram of a memory system according to some example embodiments.

### DETAILED DESCRIPTION

Hereinafter, example embodiments will be described with reference to the accompanying drawings.

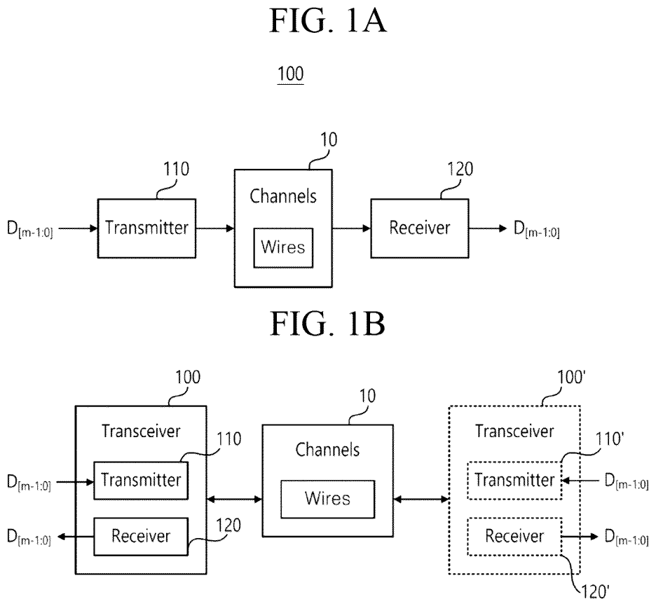

FIG. 1A is a block diagram of a communication system 100 according to some example embodiments. Referring to FIG. 1A, the communication system 100 may include a transmitter 110 and a receiver 120.

A plurality of channels 10 may be paths, physically or electrically connecting the transmitter 110 and the receiver 120. For example, the plurality of channels 10 may be implemented using through-silicon vias (TSVs), traces, wires, cables, or the like, but example embodiments are not limited thereto.

The transmitter 110 may encode binary bits of each of a plurality of data streams into a plurality of symbols, and may convert the plurality of symbols into a plurality of output signals, respectively corresponding to the plurality of channels 10, based on a transmission rule defined by an encoding matrix (hereinafter referred to as a “first matrix”).

For example, when m data streams D₀ to Dₘ₋₁ are input in parallel, the transmitter 110 may encode binary bits, input through each data stream, to generate m symbols. In some example embodiments, the transmitter 110 may encode binary bits into symbols based on an encoding rule defined to reduce (and/or minimize) decoding errors caused by additive white Gaussian noise (AWGN).

The transmitter 110 may convert the m generated symbols into a plurality of output signals, and transmit the converted output signals through the plurality of channels 10, respectively. For example, when the number of channels 10 is n (n is a positive integer larger than m), the transmitter 110 may combine the m symbols based on a transmission rule, defined by a first matrix, to generate n output signals. Accordingly, the transmitter 110 may transmit the n generated output signals through the n channels, respectively.

In some example embodiments, the first matrix may be an n×m integer matrix, and row vectors of the first matrix may correspond to the plurality of channels 10, respectively. Accordingly, each of the n output signals may have a voltage level based on an inner product of a row vector corresponding to a channel, among row vectors of the first matrix, and a column vector including m symbols.

The receiver 120 may combine a plurality of output signals received through the plurality of channels 10 based on a reception rule defined by a decoding matrix (hereinafter referred to as a “second matrix”) to restore a plurality of symbols, and may decode the restored symbols into binary bits.

For example, when n output signals are received through the plurality of channels 10, the receiver 120 may combine at least a portion of the n output signals based on a reception rule defined by the second matrix to restore the m symbols.

In some example embodiments, the second matrix may be an m×n integer matrix, and row vectors of the second matrix may correspond to the plurality of symbols, respectively. Accordingly, each of the m symbols may be restored based on an inner product of a row vector corresponding to a symbol, among row vectors of the second matrix, and a column vector including the n output signals.

Accordingly, the receiver 120 may decode the m restored symbols into m binary bits, respectively. For example, the receiver 120 may obtain binary bits, respectively corresponding to the restored m symbols, based on an inverse rule of the encoding rule of the transmitter 110 (for example, an encoding rule defined to reduce (and/or minimize) encoding errors caused by AWGN).

According to an some example embodiments, the above-described first and second matrices may be determined to reduce (and/or minimize) a crosstalk effect between adjacent channels, among the plurality of channels 10. For example, output signals transmitted from the transmitter 110 are transmitted through the plurality of channels 10, so that the receiver 120 may receive an output signal to which a crosstalk component caused by adjacent channels are added. Accordingly, the output signal of the transmitter 110 received by the receiver 120 may be expressed as a sum of a signal component related to data and a crosstalk component caused by a crosstalk effect between adjacent channels. According to some example embodiments, the first matrix and the second matrix may be determined to reduce (and/or minimize) a maximum value of the crosstalk component.

As will be described later, according to some example embodiments, the transmitter 110 and the receiver 120 may be implemented in hardware, respectively, based on the first matrix and the second matrix. Accordingly, the first and second matrices may be determined to reduce (and/or minimize) the crosstalk effect between adjacent channels, and thus output signals reducing (and/or minimizing) the crosstalk effect between adjacent channels may be transmitted and received by the transmitter 110 and receiver 120, respectively.

According to some example embodiments, elements of first matrices may be determined such that a sum of the elements of the column vectors of the first matrix is 0. In some example embodiments, a sum of voltage levels of the plurality of output signals applied to the plurality of channels 10 may remain constant over time. For example, the voltage level of each output signal may change every unit interval (UI), but the sum of the voltage levels of all output signals may be maintained constant regardless of the UI. According to some example embodiments, the voltage levels that the plurality of output signals may have may be output while changing an order every UI. In some example embodiments, a sum of currents flowing through the plurality of channels is maintained constant, so that simultaneous switching noise (SSN) may be eliminated.

According to some example embodiments, the plurality of symbols described above may be ternary or higher symbols. For example, when the plurality of symbols are ternary symbols, three binary bits may be encoded into a ternary symbol of 2UI. In some example embodiments, binary bits may be transmitted at 1.5 times the speed of transmission when the binary bits are transmitted without being encoded into symbols. However, when the plurality of symbols are quaternary symbols, two binary bits may be encoded into a quaternary symbol, so that binary bits may be transmitted at two times the speed of transmission.

As described above, binary bits are encoded into symbols based on an encoding rule defined to reduce (and/or minimize) decoding errors caused by AWGN and symbols may be decoded into binary bits based on an inverse rule of the encoding rule. Therefore, a bit error rate (BER) may be reduced (and/or minimized) during transmission and restoration of data,

FIG. 1B is a block diagram of a communication system 100 according to some example embodiments. In FIG. 1A, the communication system 100 has been described by taking an example in which the transmitter 110 and the receiver 120 are different devices connected through the plurality of channels 10. However, the configuration of the communication system 100 is not limited thereto.

For example, the communication system 100 may be included in a single transceiver. Referring to FIG. 1B, the communication system 100 may be implemented as a single transceiver including the transmitter 110 and receiver 120 described in FIG. 1A.

In some example embodiments, the communication system 100 may be connected to another communication system 100′, including a transmitter 110′ and a receiver 120′, through a plurality of channels 10 to transmit and receive data.

The transmitters 110 and 110′ and receivers 120 and 120′ included in the communication systems 100 and 100′ of FIG. 1B are substantially the same as the transmitter 110 and receiver 120 described above in FIG. 1A, so that redundant descriptions are omitted.

Hereinafter, for ease of description, various embodiments will be described with reference to the communication system 100 having the configuration illustrated in FIG. 1A. However, the corresponding descriptions may be equally applied to the communication systems 100 and 100′ having the configurations illustrated in FIG. 1B as long as there is no contradiction therebetween.

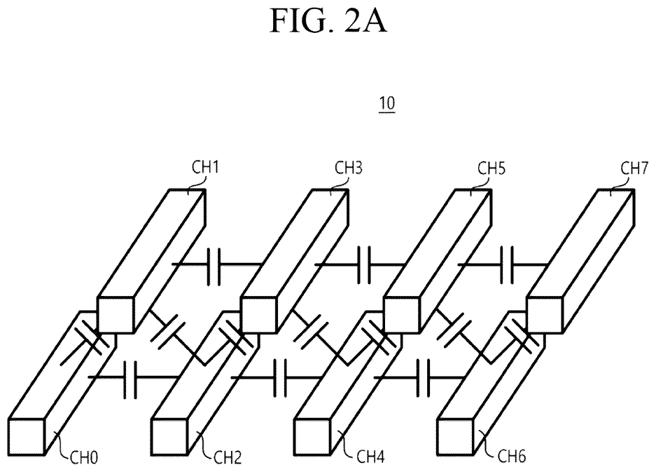

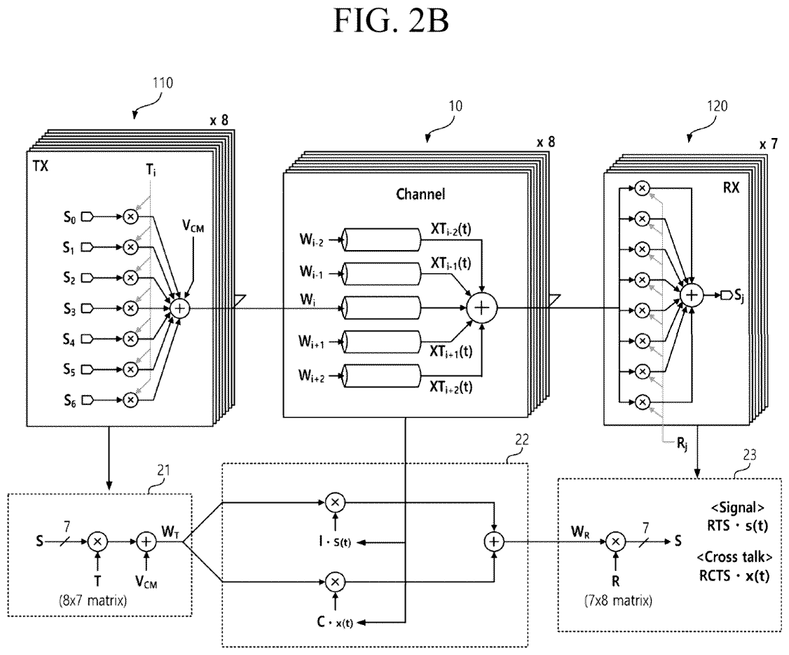

FIG. 2A is a diagram illustrating a plurality of channels according to some example embodiments.

Referring to FIG. 2A, a plurality of channels CH0 to CH7 may be electrically connected between a transmitter 110 and a receiver 120. Each of eight output signals, output from the transmitter 110, may be transmitted to the receiver 120 through a corresponding channel.

In this some example embodiments, a capacitance component present between channels may cause crosstalk in which signals of adjacent channels are coupled. For example, a crosstalk effect may occur in CH0 due to two adjacent channels CH1 and CH2. A crosstalk effect may occur in CH1 due to three adjacent channels CH0, CH2, and CH3. A crosstalk effect may occur in CH2 due to four adjacent channels CH0, CH1, CH3, and CH4. Similarly, crosstalk may occur in CH7 due to two adjacent channels, in CH6 due to three adjacent channels, and in CH3, CH4, and CH5 due to four adjacent channels.

According to some example embodiments, the plurality of channels CH0 to CH7 may have a symmetrical structure. The plurality of channels CH0 to CH7 may have the same coupling strength. In some example embodiments, crosstalk effects between adjacent channels may be all the same. Accordingly, when a crosstalk effect is expressed as “1,” a crosstalk effect between the plurality of channels CH0 to CH7 may be modeled as illustrated in the following Equation 1.

$$C = [ \begin{matrix}0 & 1 & 1 & 0 & 0 & 0 & 0 & 0 \\ 1 & 0 & 1 & 1 & 0 & 0 & 0 & 0 \\ 1 & 1 & 0 & 1 & 1 & 0 & 0 & 0 \\ 0 & 1 & 1 & 0 & 1 & 1 & 0 & 0 \\ 0 & 0 & 1 & 1 & 0 & 1 & 1 & 0 \\ 0 & 0 & 0 & 1 & 1 & 0 & 1 & 1 \\ 0 & 0 & 0 & 0 & 1 & 1 & 0 & 1 \\ 0 & 0 & 0 & 0 & 0 & 1 & 1 & 0\end{matrix} ] \qquad Equation 1$$

where C is a matrix obtained by modeling crosstalk effects between a plurality of channels (hereinafter referred to as a “third matrix”).

Referring to a third matrix of Equation 1, first to eighth column vectors may model CH0 to CH7, respectively. For example, CH0 and CH7 are affected by crosstalk from two adjacent channels, so that two elements of the first and eighth column vectors may be represented as “1.” CH1 and CH6 are affected by crosstalk from three adjacent channels, so that three elements of the second and seventh column vectors may be represented as “1.” CH2, CH3, CH4, and CH5 are affected by crosstalk from four adjacent channels, four elements of the third to sixth column vectors may be represented as “1.” The above-described content is the same even with respect to row vectors.

As will be described later, the third matrix may be used during a process of determining the first matrix and the second matrix to reduce (and/or minimize) crosstalk of adjacent channels. In FIG. 2A, eight channels having the same coupling strength have been described as having a symmetrical structure, but example embodiments are not limited to this. For example, any number of different channels having arbitrary channel responses may be modeled as a third matrix. Such a modeled third matrix may be used during the process of determining the first and second matrices to reduce (and/or minimize) a crosstalk effect between adjacent channels.

FIG. 2B is a diagram illustrating a signaling model of a communication system according to some example embodiments. FIG. 2B illustrates an example in which seven binary data streams Do to D₆ are transmitted through eight channels, but example embodiments are not limited thereto.

The transmitter 110 may encode a plurality of binary data streams Do to D₆ into a plurality of symbols S₀ to S₆, respectively. In FIG. 2B, S₀ to S₆ illustrated in TX represent seven encoded symbols.

The transmitter 110 may generate an output signal Wᵢ based on the symbols S₀ to S₆. The output signal Wᵢ represents an output signal corresponding to an i-th channel, among the eight channels. The output signal Wᵢ may have a voltage level based on an inner product of a row vector Tᵢ, corresponding to an i-th channel of a first matrix T, and a column vector S including the symbols S₀ to S₆.

According to some example embodiments, the output signal Wᵢ may be expressed as a form in which weights are multiplied by the symbols S₀ to S₆ according to the elements of the row vector Tᵢ and a common mode voltage V_{CM} having an appropriate magnitude is added. Referring to a reference numeral 21, the transmitter 110 may perform an affine transform on the symbols S₀ to S₆ based on the first matrix T and the common mode voltage V_{CM} to generate output signals W_{T}.

Each of the generated output signals W_{T} may be transmitted to the receiver 120 through a corresponding channel. In this some example embodiments, an output signal transmitted through each channel may be affected by crosstalk from output signals transmitted through adjacent channels. For example, referring to FIG. 2B, when the i-th channel is adjacent to four channels (an i−2-th channel, an i−1-th channel, an i+1-th channel, and an i+2-th channel), crosstalk effects Xᵢ₋₂(t), Xᵢ₋₁(t), Xᵢ₊₁(t), and Xᵢ₊₂(t) of the above four channels may be added to the output signal Wᵢ transmitted through the i-th channel.

When the i-th channel is adjacent to three channels (for example, an i−1-th channel, an i+1-th channel, and an i+2-th channel), crosstalk effects Xᵢ₋₁(t), Xᵢ₊₁(t), and Xᵢ₊₂(t) of the three channels may be added to the output signal Wᵢ. When the i-th channel is adjacent to two channels (for example, an i+1-th channel and an i+2-th channel), crosstalk effects Xᵢ₊₁(t) and Xᵢ₊₂(t) of the two adjacent channels may be added to the output signal Wᵢ.

In reference numeral 22, I·s(t) represents an output signal component of each channel and C·x(t) represents a crosstalk component added to a corresponding channel, where I is an 8×8 identity matrix, S(t) is a single bit response (SBR) of the output signal, C is a third matrix obtained by modeling the crosstalk effects between eight channels, and x(t) is a crosstalk pulse response (CPR).

The receiver 120 may receive output signals through channels 10. In some example embodiments, the receiver 120 may receive output signals W_{R} to which crosstalk elements of adjacent channels are added, rather than receive the output signals W_{T}, generated by the transmitter 110, as it is.

The receiver 120 may restore the seven symbols S₀ to S₆ based on the output signals W_{R} received through the channels 10, respectively. Referring to RX in FIG. 2B, the receiver 120 may restore the symbol Sⱼ based on output signals received through the eight channels 10. The symbol Sⱼ represents a j-th symbol, among the seven symbols. The symbol Sⱼ may be restored based on an inner product of a row vector Rⱼ, corresponding to the j-th symbol of the second matrix R, and a column vector W_{R} including received output signals. Referring to reference numeral 23, the receiver 120 may perform linear transformation on the received output signals W_{R} based on the second matrix R to restore a plurality of symbols S.

Accordingly, the receiver 120 may decode the restored symbols S₀ to S₆ into binary bits, respectively.

A waveform of the symbol restored in the receiver 120 may be expressed as a series of SBR, and may appear in the form in which CPR is added to every UI by crosstalk. For example, a 1UI waveform of the restored symbols may be expressed as the following Equation 2.

$$RTS \cdot s ( t ) + RCTS \cdot x ( t ) \qquad Equation 2$$

where T is the first matrix, R is the second matrix, C is the third matrix, S is a column vector including values of a plurality of symbols, s(t) is SBR, and x(t) is CPR.

Thus, according to some example embodiments, by determining the first and second matrices T and R that reduce (and/or minimize) a maximum value of an absolute value of RCTS, a crosstalk effect between adjacent channels can be reduced (and/or minimized).

For example, in some example embodiments in which m data streams are driven on n wires, the first matrix T and the second matrix R may be determined based on the following Equation 3. In some example embodiments, n may be an integer greater than m. For example, n may be an integer greater than or equal to 2 and less than 10, but example embodiments are not limited thereto.

$$arg {min}_{T , R} max ( abs ( ( {R}_{eff} \cdot C \cdot {T}_{eff} - diag ( {R}_{eff} \cdot C \cdot {T}_{eff} ) ) \times [ \begin{matrix}1 \\ ⋮ \\ 1\end{matrix} ] ) ) \qquad Equation 3$$

$${T}_{eff} = diag ( \frac{1}{{t}_{1}} , \frac{1}{{t}_{2}} , … , \frac{1}{{t}_{n}} ) \cdot T$$

$${R}_{eff} = diag ( {g}_{1} , {g}_{2} , … , {g}_{m} ) \cdot R$$

$${t}_{i} = [ \begin{matrix}{δ}_{i 1} & {δ}_{i 2} & … & {δ}_{in}\end{matrix} ] \cdot abs ( T ) \cdot [ \begin{matrix}1 \\ ⋮ \\ 1\end{matrix} ] , \{ \begin{matrix}{δ}_{ij} = 1 ( when i = j ) \\ {δ}_{ij} = 0 ( when i \neq j )\end{matrix}$$

where T is a first matrix, R is a second matrix, C is a third matrix, tᵢ is an L1 norm of an i-th row vector of the first matrix T, and diag means a diagonal matrix. L1 norm may be defined as a measure of the length or magnitude of the vector. And, g₁ may be determined to be a specific value based on limiting conditions to be described later.

Referring to Equation 3, T and R may be determined to reduce (and/or minimize) a maximum value of an absolute value of R_{eff}·C·T_{eff}.

According to an example embodiment, T and R may satisfy the following limiting conditions.

Condition 1:

$${R}_{eff} \cdot {T}_{eff} = {I}_{m}$$

Condition 2: T is an n×m integer matrix, and R is an m×n integer matrix

Condition 3: a sum of elements of a column vector of T is 0

Condition 4: an L1 norm of the row vector of T is limited within a threshold value

For example, according to Condition 1, orthogonality is present between R_{eff} and T_{eff}. This may be a condition for restoring symbols transmitted from the transmitter 110 in the receiver 120.

According to some example embodiments, hardware configurations of the transmitter 110 and the receiver 120 may be determined based on the first and second matrices. For example, as will be described in detail later, an input signal of the encoder of the transmitter 110, the number of drivers of the transmitter 110, an input signal of a differential amplifier of the receiver 120, or the like, may be determined based on the first and second matrices. Accordingly, the second condition and the fourth condition may be conditions for implementing the transmitter 110 and the receiver 120 in hardware. In some example embodiments, a threshold value of the fourth condition may be, for example, 10, but example embodiments are not limited thereto.

As described above, output signals generated by the transmitter 110 may have voltage levels based on an inner product of a row vector, corresponding to a channel in the first matrix, and a column vector including a plurality of symbols. Accordingly, when Condition 3 is satisfied, a sum of the voltage levels of the output signals of the transmitter 110 may remain constant over time. As a result, Condition 3 may be a condition for removing SSN.

T and R, satisfying the above-described limiting conditions, are necessarily determined to be finite. The following Equation 4 and Equation 5 represent an example of the first matrix T and an example of the second matrix R, satisfying the above-described limiting conditions, in an example embodiment in which seven data streams are driven on eight wires (for example, 8 channels), respectively.

$$T = [ \begin{matrix}4 & 0 & - 3 & 0 & 0 & 0 & - 2 \\ - 4 & 0 & - 3 & 0 & 0 & 0 & - 2 \\ 0 & - 4 & 3 & 0 & 0 & 0 & - 2 \\ 0 & 4 & 3 & 0 & 0 & 0 & - 2 \\ 0 & 0 & 0 & - 4 & 0 & - 3 & 2 \\ 0 & 0 & 0 & 4 & 0 & - 3 & 2 \\ 0 & 0 & 0 & 0 & - 4 & 3 & 2 \\ 0 & 0 & 0 & 0 & 4 & 3 & 2\end{matrix} ] \qquad Equation 4$$

$$R = [ \begin{matrix}1 & - 1 & 0 & 0 & 0 & 0 & 0 & 0 \\ 0 & 0 & - 1 & 1 & 0 & 0 & 0 & 0 \\ - 1 & - 1 & 1 & 1 & 0 & 0 & 0 & 0 \\ 0 & 0 & 0 & 0 & - 1 & 1 & 0 & 0 \\ 0 & 0 & 0 & 0 & 0 & 0 & - 1 & 1 \\ 0 & 0 & 0 & 0 & - 1 & - 1 & 1 & 1 \\ - 1 & - 1 & - 1 & - 1 & 1 & 1 & 1 & 1\end{matrix} ] \qquad Equation 5$$

Referring to Equations 4 and 5, T is an 8×7 integer matrix, and R is a 7×8 integer matrix. Therefore, Condition 2 is satisfied.

Elements of a first column vector of T are 4, −4, 0, 0, 0, 0, 0, 0, and a sum thereof is 0. Elements of a seventh column vector of T are −2, −2, −2, −2, 2, 2, 2, 2, and a sum thereof is 0. This is equally applied to elements of the remaining second to sixth column vectors. Therefore, Condition 3 is satisfied.

An L1 norm of the first row vector of T is 9 (=|4|+|0|+|−3|+|0|+|0|+|0|+|−2|), which is equally applied to second to eighth row vectors. Therefore, Condition 4 is satisfied. Condition 4 does not mean that L1 norm values of the row vectors of the first matrix should all be the same. Therefore, the L1 norm values of all row vectors are the same as 9 in T of Equation 4, but the L1 norm value may vary for each row vector according to some example embodiments. The L1 norm of each row vector is limited to within the threshold value.

T_{eff} may be expressed as the following Equation 6.

$${T}_{eff} = diag ( \frac{1}{{t}_{1}} , \frac{1}{{t}_{2}} , … , \frac{1}{{t}_{n}} ) \cdot T = [ \begin{matrix}4 / 9 & 0 & - 1 / 3 & 0 & 0 & 0 & - 2 / 9 \\ - 4 / 9 & 0 & - 1 / 3 & 0 & 0 & 0 & - 2 / 9 \\ 0 & - 4 / 9 & 1 / 3 & 0 & 0 & 0 & - 2 / 9 \\ 0 & 4 / 9 & 1 / 3 & 0 & 0 & 0 & - 2 / 9 \\ 0 & 0 & 0 & - 4 / 9 & 0 & - 1 / 3 & 2 / 9 \\ 0 & 0 & 0 & 4 / 9 & 0 & - 1 / 3 & 2 / 9 \\ 0 & 0 & 0 & 0 & - 4 / 9 & 1 / 3 & 2 / 9 \\ 0 & 0 & 0 & 0 & 4 / 9 & 1 / 3 & 2 / 9\end{matrix} ] \qquad Equation 6$$

$$diag ( \frac{1}{{t}_{1}} , \frac{1}{{t}_{2}} , … , \frac{1}{{t}_{n}} ) = [ \begin{matrix}1 / 9 & 0 & 0 & 0 & 0 & 0 & 0 & 0 \\ 0 & 1 / 9 & 0 & 0 & 0 & 0 & 0 & 0 \\ 0 & 0 & 1 / 9 & 0 & 0 & 0 & 0 & 0 \\ 0 & 0 & 0 & 1 / 9 & 0 & 0 & 0 & 0 \\ 0 & 0 & 0 & 0 & 1 / 9 & 0 & 0 & 0 \\ 0 & 0 & 0 & 0 & 0 & 1 / 9 & 0 & 0 \\ 0 & 0 & 0 & 0 & 0 & 0 & 1 / 9 & 0 \\ 0 & 0 & 0 & 0 & 0 & 0 & 0 & 1 / 9\end{matrix} ]$$

R_{eff} may be expressed as the following Equation 7.

$${R}_{eff} = diag ( {g}_{1} , {g}_{2} , … , {g}_{m} ) \cdot R = [ \begin{matrix}9 / 8 & - 9 / 8 & 0 & 0 & 0 & 0 & 0 & 0 \\ 0 & 0 & - 9 / 8 & 9 / 8 & 0 & 0 & 0 & 0 \\ - 3 / 4 & - 3 / 4 & 3 / 4 & 3 / 4 & 0 & 0 & 0 & 0 \\ 0 & 0 & 0 & 0 & - 9 / 8 & 9 / 8 & 0 & 0 \\ 0 & 0 & 0 & 0 & 0 & 0 & - 9 / 8 & 9 / 8 \\ 0 & 0 & 0 & 0 & - 3 / 4 & - 3 / 4 & 3 / 4 & 3 / 4 \\ - 9 / 16 & - 9 / 16 & - 9 / 16 & - 9 / 16 & 9 / 16 & 9 / 16 & 9 / 16 & 9 / 16\end{matrix} ] \qquad Equation 7$$

$$diag ( {g}_{1} , {g}_{2} , … , {g}_{m} ) = [ \begin{matrix}9 / 8 & 0 & 0 & 0 & 0 & 0 & 0 \\ 0 & 9 / 8 & 0 & 0 & 0 & 0 & 0 \\ 0 & 0 & 3 / 4 & 0 & 0 & 0 & 0 \\ 0 & 0 & 0 & 9 / 8 & 0 & 0 & 0 \\ 0 & 0 & 0 & 0 & 9 / 8 & 0 & 0 \\ 0 & 0 & 0 & 0 & 0 & 3 / 4 & 0 \\ 0 & 0 & 0 & 0 & 0 & 0 & 9 / 16\end{matrix} ]$$

Accordingly, R_{eff}·T_{eff} is a 7×7 identity matrix, as illustrated in the following Equation 8.

$${R}_{eff} \cdot {T}_{eff} = [ \begin{matrix}1 & 0 & 0 & 0 & 0 & 0 & 0 \\ 0 & 1 & 0 & 0 & 0 & 0 & 0 \\ 0 & 0 & 1 & 0 & 0 & 0 & 0 \\ 0 & 0 & 0 & 1 & 0 & 0 & 0 \\ 0 & 0 & 0 & 0 & 1 & 0 & 0 \\ 0 & 0 & 0 & 0 & 0 & 1 & 0 \\ 0 & 0 & 0 & 0 & 0 & 0 & 1\end{matrix} ] \qquad Equation 8$$

Therefore, Condition 1 is satisfied.

The first matrix T and the second matrix R, satisfying the above-described limiting conditions, are not limited to Equations 4 and 5. The following Equations 9 and 10 represent an example of the first matrix T and the second matrix R, satisfying the above-described limiting conditions, in an example in which seven parallel data streams are driven on eight wires.

$$T = [ \begin{matrix}0 & 0 & 0 & 0 & - 2 & 2 & - 1 \\ 0 & 0 & 0 & - 3 & 0 & - 2 & - 1 \\ 0 & - 3 & 4 & 0 & 0 & 0 & 1 \\ - 3 & 0 & - 4 & 0 & 0 & 0 & 1 \\ 3 & 0 & - 4 & 0 & 0 & 0 & 1 \\ 0 & 3 & 4 & 0 & 0 & 0 & 1 \\ 0 & 0 & 0 & 3 & 0 & - 2 & - 1 \\ 0 & 0 & 0 & 0 & 2 & 2 & - 1\end{matrix} ] \qquad Equation 9$$

$$R = [ \begin{matrix}0 & 0 & 0 & - 3 & 3 & 0 & 0 & 0 \\ 0 & 0 & - 3 & 0 & 0 & 3 & 0 & 0 \\ 0 & 0 & 4 & - 4 & - 4 & 4 & 0 & 0 \\ 0 & - 3 & 0 & 0 & 0 & 0 & 3 & 0 \\ - 2 & 0 & 0 & 0 & 0 & 0 & 0 & 2 \\ 2 & - 2 & 0 & 0 & 0 & 0 & - 2 & 2 \\ - 1 & - 1 & 1 & 1 & 1 & 1 & - 1 & - 1\end{matrix} ] \qquad Equation 10$$

The following Equations 11 and 12 represent an example of the first matrix T and the second matrix R, satisfying the above-described limiting conditions, in an example embodiment in which five parallel data streams are driven on six wires (for example, six channels).

$$T = [ \begin{matrix}1 & - 1 & 0 & 0 & - 1 \\ - 1 & - 1 & 0 & 0 & - 1 \\ 0 & 2 & 0 & 0 & - 1 \\ 0 & 0 & - 1 & - 1 & 1 \\ 0 & 0 & 1 & - 1 & 1 \\ 0 & 0 & 0 & 2 & 1\end{matrix} ] \qquad Equation 11$$

$$R = [ \begin{matrix}1 & - 1 & 0 & 0 & 0 & 0 \\ - 1 & - 1 & 2 & 0 & 0 & 0 \\ 0 & 0 & 0 & - 1 & 1 & 0 \\ 0 & 0 & 0 & - 1 & - 1 & 2 \\ - 1 & - 1 & - 1 & 1 & 1 & 1\end{matrix} ] \qquad Equation 12$$

According to various embodiments, the transmitter 110 and the receiver 120 may be implemented based on T and R determined as above, which will be described in detail later. In example embodiments, crosstalk between adjacent channels may be reduced (and/or minimized and SSN may be removed during data transmission and reception.

Hereinafter, for ease of description, various embodiments will be described with reference to the first and second matrices of Equations 4 and 5, but the descriptions may be equally applied to the first matrix and the second matrix of Equations 9 to 12 as long as there is no contradiction therebetween.

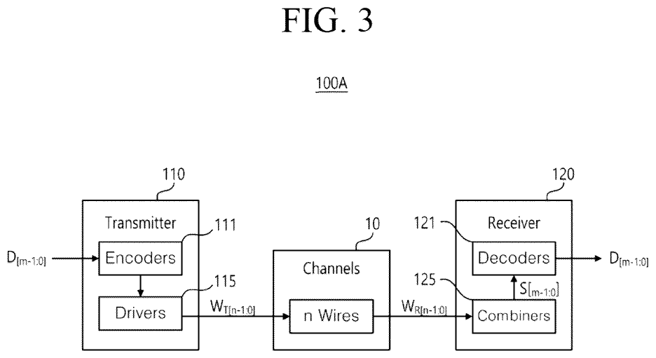

FIG. 3 is a block diagram illustrating an example of how to implement a communication system according to some example embodiments. Referring to FIG. 3, a communication system 100A may include a transmitter 110 and a receiver 120.

The transmitter 110 may convert m parallel data streams D₀ to Dₘ₋₁ to generate n output signals W_{T[n-1:0]}, and may transmit the generated output signals W_{T[n-1:0]} through channels 10 including n wires, respectively. In some example embodiments, n may be an integer greater than or equal to m. For example, n may be m+1, but example embodiments are not limited thereto.

For example, the transmitter 110 may encode the m data streams D₀ to Dₘ₋₁ into m symbols, and may combine the m symbols, based on a transmission rule defined by a first matrix, to generate n output signals. In some example embodiments, each of the n output signals may have a voltage level based on an inner product of a row vector corresponding to a channel, among row vectors of the first matrix, and a column vector including the m symbols. As described above, the first matrix may be an n×m integer matrix determined to reduce (and/or minimize) a maximum value of a crosstalk effect between adjacent channels.

For example, the transmitter 110 may include a plurality of encoders 111 and a plurality of drivers 115. The plurality of encoders 111 may generate control signals to convert input binary data into symbol data. In some example embodiments, the plurality of encoders 111 may generate control signals based on an encoding rule defined to reduce (and/or minimize) decoding errors caused by additive white Gaussian noise (AWGN).

The plurality of drivers 115 may be driven by control signals generated by the plurality of encoders 111. The plurality of drivers 115 may generate n output signals W_{T[n-}1:0] based on control signals. For example, the plurality of drivers 115 may generate a plurality of symbols based on the control signals, and may combine the generated symbols according to the first matrix to generate output signals W_{T[n-1:0]}. In some example embodiments, the generated output signals W_{T[n-1:0]} may have a value based on symbol data in which the input binary data is encoded according to the encoding rule.

For example, when the first matrix is determined as T of Equation 4, the output signals generated by the plurality of drivers 115 may be calculated as illustrated in the following Equation 13.

$${W}_{T} = T \cdot S = [ \begin{matrix}4 & 0 & - 3 & 0 & 0 & 0 & - 2 \\ - 4 & 0 & - 3 & 0 & 0 & 0 & - 2 \\ 0 & - 4 & 3 & 0 & 0 & 0 & - 2 \\ 0 & 4 & 3 & 0 & 0 & 0 & - 2 \\ 0 & 0 & 0 & - 4 & 0 & - 3 & 2 \\ 0 & 0 & 0 & 4 & 0 & - 3 & 2 \\ 0 & 0 & 0 & 0 & - 4 & 3 & 2 \\ 0 & 0 & 0 & 0 & 4 & 3 & 2\end{matrix} ] \cdot [ \begin{matrix}{S}_{0} \\ {S}_{1} \\ {S}_{2} \\ {S}_{3} \\ {S}_{4} \\ {S}_{5} \\ {S}_{6}\end{matrix} ] \qquad Equation 13$$

where W_{T} is the output signals generated by the plurality of drivers 115, T is the first matrix T of Equation 4, and S is a column vector including seven symbols.

A calculation result based on Equation 13 is listed in the following Table 1.

TABLE 1

| Output Signal | Voltage Level |
|---|---|
| W_{T0} | 4S₀ − 3S₂ − 2S₆ |
| W_{T1} | −4S₀ − 3S₂ − 2S₆ |
| W_{T2} | −4S₁ + 3S₂ − 2S₆ |
| W_{T3} | 4S₁ + 3S₂ − 2S₆ |
| W_{T4} | −4S₃ − 3S₅ + 2S₆ |
| W_{T5} | 4S₃ − 3S₅ + 2S₆ |
| W_{T6} | −4S₄ + 3S₅ + 2S₆ |
| W_{T7} | 4S₄ + 3S₅ + 2S₆ |

Referring to Equation 13 and Table 1, each of the output signals W_{T0} to W_{T7} generated by the plurality of drivers 115 may have a voltage level based on an inner product of a row vector corresponding to a channel, among the row vectors of the first matrix, and a column vector S including seven symbols S₀ to S₆. To this end, in some example embodiments, the plurality of drivers 115 may be configured to perform a multiplication operation between a first matrix and a column vector including a plurality of symbols. This will be described in detail later.

In this some example embodiments, when the symbol S is, for example, a ternary symbol having three levels such as −1, 0, and +1, the output signal W_{T0} may have 17 levels such as 9, −7, −6, −5, −4, −3, −2, −1, 0, 1, 2, 3, 4, 5, 6, 7, and 9 according to values of S₀, S₂, and S₆. However, an output voltage of the plurality of drivers 115 is limited within a range of a driving voltage applied to each driver. Therefore, for example, when a driving voltage is VDDQ[V] and a ground voltage is 0[V], an actual voltage level of the output signal W_{T0} may have a normalized value between 0[V] and VDDQ[V]. This may be equally applied to the remaining output signals W_{T1} to W_{T7}.

According to some example embodiments, an actual voltage value of the output signal W_{T} applied to a wire may be calculated based on the following Equation 14.

$${W}_{T} = 0.5 \cdot VDDQ \cdot ( {T}_{eff} \cdot S + [ \begin{matrix}1 \\ ⋮ \\ 1\end{matrix} ] ) \qquad Equation 14$$

where W_{T} is an actual voltage level of an output signal generated by the transmitter 110, VDDQ is a driving voltage applied to a plurality of drivers, and S is a column vector including a plurality of symbols. And, T_{eff} is the same as described above in Equation 3.

When the output signals W_{R[n-1:0]} are received through the channels 10 including n wires, the receiver 120 may restore the plurality of symbols based on the plurality of received output signals W_{R[n-1:0]} and may decode the restored symbols into binary bits.

For example, the receiver 120 may include a plurality of combiners 125 and a plurality of decoders 121. The plurality of combiners 125 may combine the plurality of received output signals W_{R[n-1:0]} to restore the plurality of symbols S_{[m-1:0]}. In some example embodiments, the plurality of combiners 125 may combine the plurality of output signals W_{R[n-1:0]} based on a reception rule defined by the second matrix. Accordingly, each of the plurality of symbols may be restored based on an inner product of a row vector corresponding to the symbol, among the row vectors of the second matrix, and a column vector including the plurality of received output signals. As described above, the second matrix may be an m×n integer matrix determined to reduce (and/or minimize) a maximum value of crosstalk effects between adjacent channels.

For example, when the second matrix is determined as R of Equation 5, the plurality of symbols restored by the plurality of combiners 125 may be calculated as illustrated in the following Equation 15.

$$S = R \cdot {W}_{R} = [ \begin{matrix}1 & - 1 & 0 & 0 & 0 & 0 & 0 & 0 \\ 0 & 0 & - 1 & 1 & 0 & 0 & 0 & 0 \\ - 1 & - 1 & 1 & 1 & 0 & 0 & 0 & 0 \\ 0 & 0 & 0 & 0 & - 1 & 1 & 0 & 0 \\ 0 & 0 & 0 & 0 & 0 & 0 & - 1 & 1 \\ 0 & 0 & 0 & 0 & - 1 & - 1 & 1 & 1 \\ - 1 & - 1 & - 1 & - 1 & 1 & 1 & 1 & 1\end{matrix} ] \cdot [ \begin{matrix}{W}_{R 0} \\ {W}_{R 1} \\ {W}_{R 2} \\ {W}_{R 3} \\ {W}_{R 4} \\ {W}_{R 5} \\ {W}_{R 6} \\ {W}_{R 7}\end{matrix} ] \qquad Equation 15$$

where S is the plurality of symbols restored by the plurality of combiners 125, R is the second matrix R of Equation 5, and W_{R} is a column vector including the plurality of received output signals.

A calculation result based on Equation 15 is listed in the following Table 2.

TABLE 2

| Symbol | Value |
|---|---|
| S₀ | W_{R0} − W_{R1} |
| S₁ | −W_{R2} + W_{R3} |
| S₂ | −W_{R0} − W_{R1} + W_{R2} + W_{R3} |
| S₃ | −W_{R4} + W_{R5} |
| S₄ | −W_{R6} + W_{R7} |
| S₅ | −W_{R4} − W_{R5} + W_{R6} + W_{R7} |
| S₆ | −W_{R0} − W_{R1} − W_{R2} − W_{R3} + |
| | W_{R4} + W_{R5} + W_{R6} + W_{R7} |

Referring to Equation 15 and Table 2, each of the plurality of symbols S₀ to S₆ may be restored based on an inner product of a row vector corresponding to a symbol, among row vectors of a second matrix, and a column vector W_{R} including the plurality of received output signals W_{R0} to W_{R7}. To this end, according to some example embodiments, the plurality of combiners 125 may be configured to perform a multiplication operation between the second matrix and the column vector including the plurality of received output signals. This will be described in detail later.

According to some example embodiments, actual levels of a plurality of symbols may be restored based on the following Equation 16.

$$S = {R}_{eff} \cdot {W}_{R} \qquad Equation 16$$

where S is a column vector including a plurality of symbols and W_{R} is a column vector including a plurality of output signals received by the receiver 120. And, R_{eff} is the same as described above in Equation 3.

As described above in Equation 3, Condition 1 (for example, R_{eff}·T_{eff}=Iₘ) should be satisfied to accurately restore the symbol transmitted from the transmitter 110, so that levels of symbols actually restored in the receiver 120 may be calculated above as in Equation 13. However, a difference between R and R_{eff} diag(g₁, g₂, . . . , gₘ) is only a constant term, so that it may be easily implemented by adjusting gains of differential amplifiers included in the plurality of combiners 125. Therefore, Equation 13 may have substantially the same meaning as Equation 12 in terms of hardware implementation.

The plurality of decoders 121 may decode the plurality of symbols, restored in the plurality of combiners 125, into binary bits, respectively. For example, the plurality of decoders 121 may obtain binary bits corresponding to the reconstructed symbol based on a plurality of sampling signals obtained by sampling symbol levels of the restored symbols.

In some example embodiments, the plurality of decoders 121 may obtain binary bits corresponding to the restored symbol based on a predefined decoding rule. According to some example embodiments, the predefined decoding rule may be an inverse rule of the above-described encoding rule (for example, an encoding rule defined to reduce (and/or minimize) decoding errors caused by AWGN).

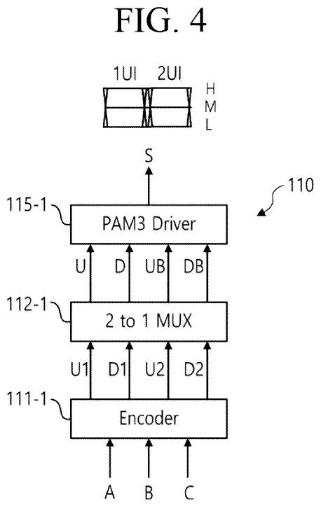

FIG. 4 is a diagram illustrating an example of a configuration of a transmitter according to some example embodiments. A symbol generation operation of the transmitter will be described with reference to FIG. 4. In FIG. 4, an example is provided in which binary bits are encoded into a ternary symbol using a pulse amplitude modulation with three levels (PAM-3) driver.

Referring to FIG. 4, a transmitter 110 may include an encoder 111-1, a 2-to-1 multiplexer (2 to 1 MUX) 112-1, and a PAM-3 driver 115-1.

The encoder 111-1 may generate control signals U1, D1, U2, and D2 based on 3 bits of binary data A, B, and C. The 3 bits of binary data may be binary data included in a single data stream, among the plurality of data streams D_{[m1:0]} described above.

According to a PAM-3 modulation scheme, 3 bits of binary data may be encoded into a ternary symbol of 2UI. Therefore, according to some example embodiments, U1 and D1 may be control signals for generating a symbol level corresponding to a first UI of 2 UI, and U2 and D2 may be control signals for generating a symbol level corresponding to a second UI of the 2 UI.

In some example embodiments, the encoder 111-1 may generate control signals U1, D1, U2, and D2 based on a rule as illustrated in the following Equation 17. This will be described in more detail later.

$$U 1 = \overline{A} \cdot C + B \qquad Equation 17$$

$$D 1 = \overline{B} + A \cdot C$$

$$U 2 = \overline{B} \cdot \overline{C} + \overline{A}$$

$$D 2 = A + B \cdot \overline{C}$$

The 2-to-1 multiplexer 112-1 may perform a re-timer function on the control signals U1, D1, U2, and D2, generated by the encoder 111-1, to control an operation of the PAM-3 driver 115-1.

For example, when four control signals U1, D1, U2, and D2 are received from the encoder 111-1, the 2-to-1 multiplexer 112-1 may provide control signals U, D, UB, and DB for generation of a first symbol level based on U1 and D1 to the PAM-3 driver 115-1. In some example embodiments, U, D, UB, and DB may be the same as U1, D1, U1B, and D1B, respectively. Here, B refers to a bar.

Then, the 2-to-1 multiplexer 112-1 may provide control signals U, D, UB, DB for generating a second symbol level based on U2 and D2 to the PAM-3 driver 115-1. In some example embodiments, U, D, UB, and DB may be the same as U2, D2, U2B, and D2B, respectively.

Accordingly, a ternary symbol of 2UI, having a symbol level for each UI, may be generated.

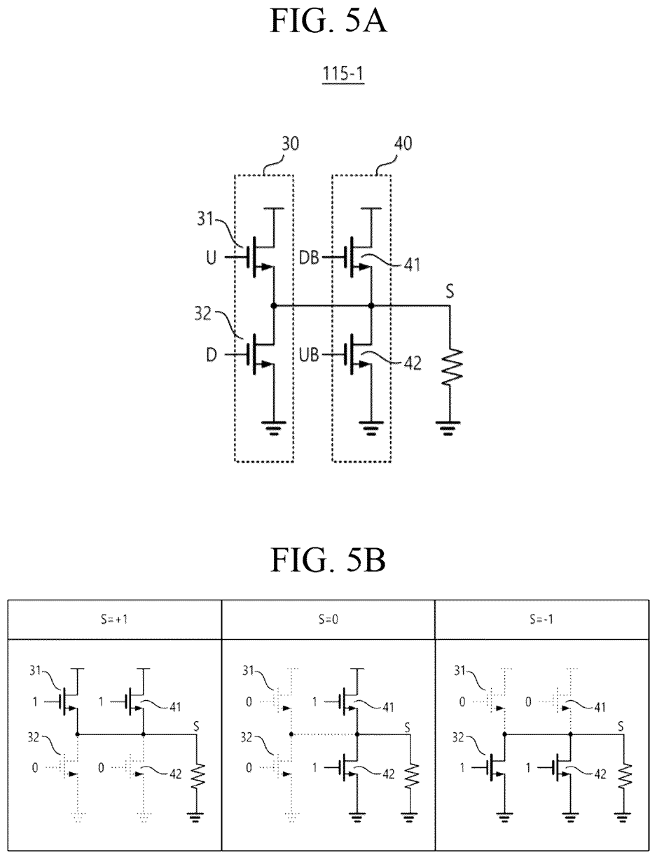

FIG. 5A is a diagram illustrating an example of a detailed configuration of a PAM-3 driver according to some example embodiments.

Referring to FIG. 5A, a PAM-3 driver 115-1 may have a structure in which two N-over-N drivers 30 and 40 are coupled to each other. In some example embodiments, control signals U, D, UB, and DB provided from the 2-to-1 multiplexer 112-1 may be respectively applied to gate terminals of four NMOS transistors 31, 32, 41, and 42 included in the two N-over-N drivers 30 and 40, as illustrated in the drawing. The PAM-3 driver 115-1 may generate a symbol S based on the control signals U, D, UB, and DB.

FIG. 5B is a diagram illustrating an operation of the PAM-3 driver of FIG. 5A.

Referring to FIG. 5B, an NMOS transistor 31 and an NMOS transistor 41 may be pulled up when U, D, UB, and DB are 1, 0, 0, and 1, respectively. Accordingly, a PAM-3 driver 115-1 may output “+1” (for example, a high level).

On the other hand, the NMOS transistor 32 and the NMOS transistor 42 may be pulled down when U, D, UB, and DB are 0, 1, 1, and 0, respectively. Accordingly, the PAM-3 driver 115-1 may output “−1” (for example, a low level).

The NMOS transistor 41 may be pulled up and the NMOS transistor 42 may be pulled down when U, D, UB, and DB are 0, 0, 1, and 1, respectively. Accordingly, the PAM-3 driver 115-1 may output “0” (for example, a middle level). Although not illustrated, the NMOS 31 transistor may be pulled up and the NMOS 32 transistor may be pulled down when U, D, UB, and DB are 1, 1, 0, and 0, respectively. Accordingly, the PAM-3 driver 115-1 may output “0” (for example, a middle level).

As described above, the PAM-3 driver 115-1 may generate a single symbol level, among the three voltage levels (+1, 0, and −1), based on the control signals U, D, UB, and DB provided from the 2-to-1 multiplexer 112-1.

The following Table 3 illustrates a rule by which 3 bits of binary data A, B, and C are encoded into a ternary symbol of 2UI, according to some example embodiments.

TABLE 3

| A | B | C | U1D1 | U2D2 | 1UI | 2UI |
|---|---|---|---|---|---|---|
| 0 | 1 | 1 | 10 | 10 | +1 | +1 |
| 0 | 1 | 0 | 10 | 11 | +1 | 0 |
| 1 | 1 | 0 | 10 | 01 | +1 | −1 |
| 1 | 1 | 1 | 11 | 01 | 0 | −1 |
| 1 | 0 | 1 | 01 | 01 | −1 | −1 |
| 1 | 0 | 0 | 01 | 11 | −1 | 0 |
| 0 | 0 | 0 | 01 | 10 | −1 | +1 |
| 0 | 0 | 1 | 11 | 10 | 0 | +1 |

| | | |
|---|---|---|
| Not Assigned | 0 | 0 |

Referring to Table 3, the encoder 111-1 may generate control signals U1D1 and U2D2 based on Equation 14. In some example embodiments, U1D1 is an expression of the above-mentioned U1 and D1 together, and U2D2 is an expression of the above-mentioned U2 and D2 together.

For example, when A, B, and C are 0, 1, and 1, Ā, B̅, and C̅ are 1, 0, and 0, respectively. Therefore, according to a logical formula of Equation 14, U1, D1, U2 and D2 may be 1, 0, 1, and 0, respectively. When Ā, B̅, and C̅ are 0, 1, and 0, A, B, and C may be 1, 0, and 1, respectively. Therefore, according to the logical formula of Equation 14, U1, D1, U2, D2 may be 1, 0, 1, and 1, respectively. The above results are the same as listed in Table 3. This may be applied to some example embodiments in which A, B, and C have different values.

The 2-to-1 multiplexer 112-1 may sequentially generate control signals U, D, UB, and DB corresponding to U1D1 and control signals U, D, UB, and DB corresponding to U2D2 to drive the PAM-3 driver 115-1. Accordingly, the PAM-3 driver 115-1 may sequentially output a first symbol level corresponding to U1D1 and a second symbol level corresponding to U2D2. In Table 3, 1UI and 2UI represent the first symbol level and the second symbol level, respectively.

For example, when U1D1 or U2D2 is 10, the control signals U, D, UB, and DB generated by the 2-to-1 multiplexer 112-1 are 1, 0, 0, and 1. Referring to FIGS. 5A and 5B, the PAM-3 driver 115-1 may output “+1”. When U1D1 or U2D2 is 01, the control signals U, D, UB, and DB generated by the 2-to-1 multiplexer 112-1 are 0, 1, 1, and 0. Referring to FIGS. 5A and 5B, the PAM-3 driver 115-1 may output “−1”, when U1D1 or U2D2 is 11, the control signals U, D, UB, and DB generated by the 2-to-1 multiplexer 112-1 are 1, 1, 0, and 0, and referring to FIGS. 5A and 5B, the PAM-3 driver 115-1 may output “0”. The above results are the same as listed in Table 3.

When 3 bits of binary data A, B, and C are encoded into a ternary symbol of 2UI using the above encoding rule, decoding errors caused by AWGN may be reduced (and/or minimized).

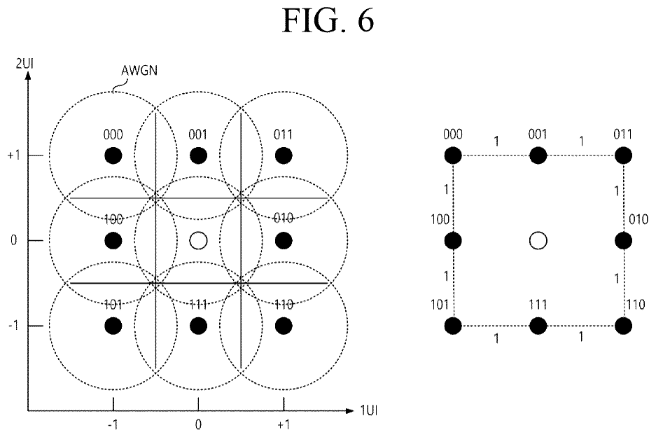

FIG. 6 is a diagram illustrating an encoding rule according to some example embodiments. In detail, FIG. 6 includes left and right constellation diagrams illustrating the encoding rule in Table 3. In the left constellation diagram, a horizontal axis represents first symbol levels “−1”, “0”, and “+1”, and a vertical axis represents second symbol levels “−1”, “0”, and “+1”.

Referring to the left constellation diagram of FIG. 6, 8 combinations of 3 binary bits may be respectively mapped to remaining 8 points, other than a point at which both a first symbol level and a second symbol level are middle levels, among 9 points. Referring to the right constellation diagram, a Hamming distance between combinations mapped to adjacent points in the constellation diagram, among the 8 mapped combinations, may be 1.

Binary bits encoded into a ternary symbol of 2UI may be decoded into other binary bits during a decoding operation due to AWGN. For example, the transmitter 110 may encode binary data “000” into a 2UI symbol having levels of “+1” and “−1”. However, AWGN occurring during transmission may cause the receiver 120 to receive a 2UI symbol having a level of “+1” and “0”. In some example embodiments, the receiver 120 may decode the received symbol into “001”. For example, the AWGN may cause the binary data “000”, transmitted from the transmitter 110, to be decoded into “001” in the receiver 120.

In some example embodiments, the AWGN has a Gaussian distribution, so that the decoding error caused by the AWGN is highly likely to occur between adjacent points on the constellation diagram, as illustrated in the left constellation diagram of FIG. 6. As described above, according to some example embodiments, a Hamming distance between binary bits mapped to adjacent points in the constellation diagram is 1, so that only a single-bit error is highly likely to occur even when an error occurs due to the AWGN. As a result, a bit error rate (BER) may be reduced (and/or minimized).

An encoding rule for reducing (and/or minimizing) the BER is not limited to that illustrated in FIG. 6. For example, according to some example embodiments, when the following two conditions are satisfied, bit errors caused by AWGN may be reduced (and/or minimized) even when binary bits are arranged on a constellation diagram in a manner, different from that illustrated in FIG. 6.

First Condition: eight combinations of three binary bits are mapped to eight points, other than a point at which both a first symbol level and a second symbol level are middle levels, among nine points in the constellation diagram.

Second Condition: a Hamming distance between combinations mapped to adjacent points of the constellation diagram, among the eight combinations mapped based on First Condition, is 1.

According to some example embodiments, a symmetrical constellation diagram may be implemented when First Condition is satisfied, according to some example embodiments, so-called Grey coding may be used to satisfy Second Condition.

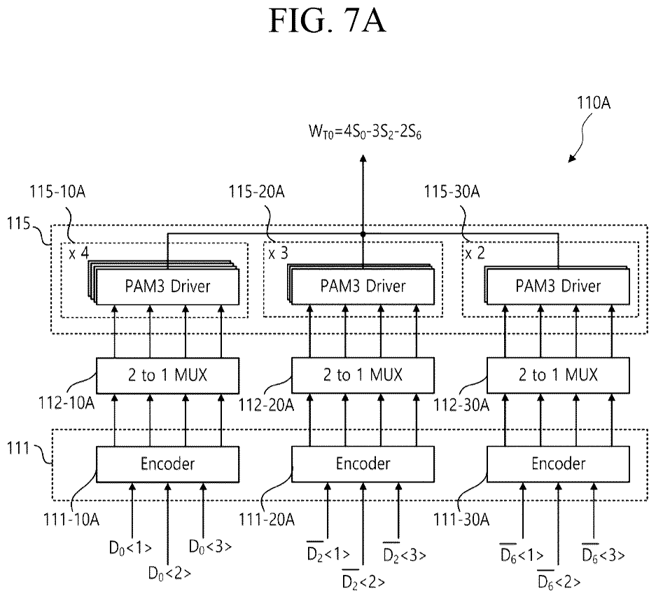

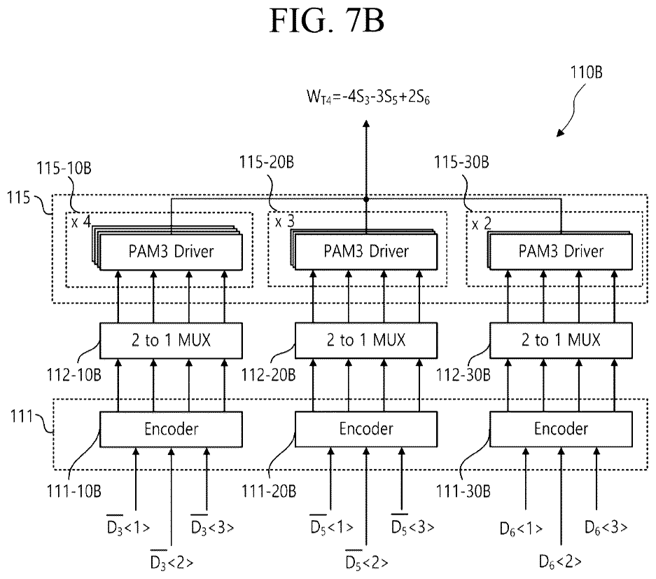

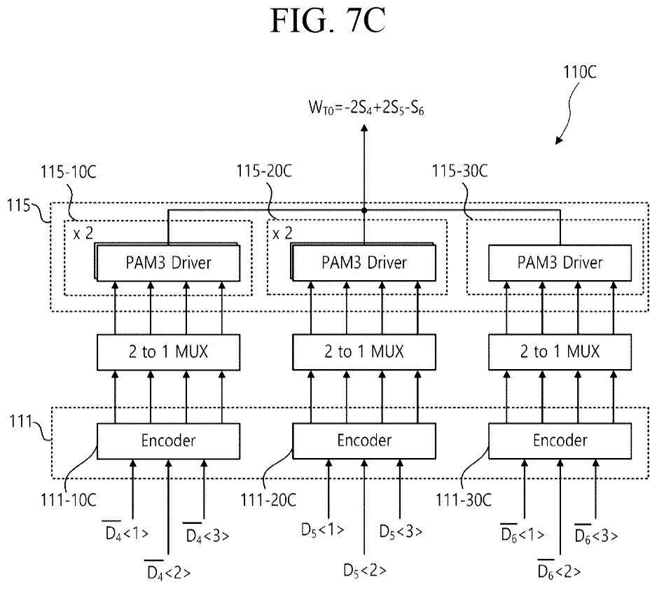

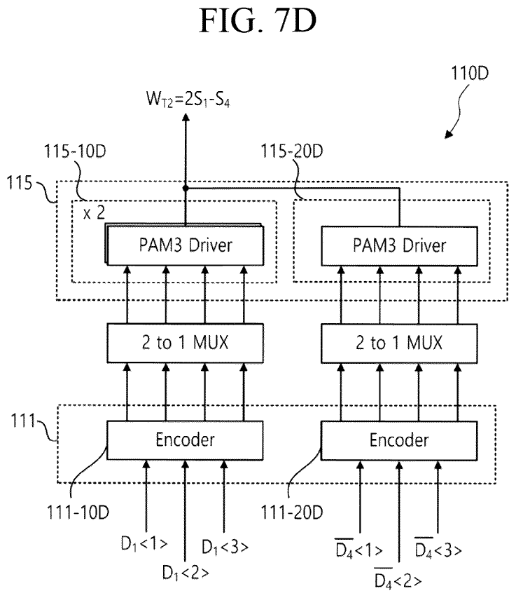

FIGS. 7A to 7D are diagrams, each illustrating a configuration of a transmitter according to some example embodiments.

As described above, a plurality of output signals generated by the transmitter 110 may correspond to a plurality of channels, respectively. Each of the plurality of output signals may have a voltage level based on an inner product of a row vector corresponding to a channel, among row vectors of a first matrix, and a column vector including a plurality of symbols. To this end, the transmitter 110 may have a configuration based on the first matrix.

For example, the transmitter 110 may include a plurality of driver groups, configured to perform an operation corresponding to the inner product, for each of a plurality of channels.

FIG. 7A illustrates an example of a configuration of a transmitter generating W_{T0}, among the output signals in Table 1. For example, W_{T0} may have a voltage level, such as 4S₀−3S₂−2S₆, based on an inner product, for example, 4·S₀+0·S₁−3·S₂+0·S₃+0·S₄+0·S₅−2·S₆, of a first row vector [4 0−3 0 0 0−2] in Equation 4 and a column vector S including 7 symbols S₀ to −S₆.

Since three types of symbols S₀, −S₂, and −S₆ are required to generate W_{T0}, the transmitter 110A may include three groups, for example, a first driver group 115-10A corresponding to S₀, a second driver group 115-20A corresponding to −S₂, and a third driver group 115-30A corresponding to −S₆.

In some example embodiments, each of the symbol S₀, −S₂, and −S₆ is multiplied by a weight based on the elements of the first row vector in Equation 4. Accordingly, the first driver group 115-10A may include four PAM-3 drivers, the second driver group 115-20A may include three PAM-3 drivers, and the third driver group 115-30A may include two PAM-3 drivers. For example, according to some example embodiments, the number of drivers included in each of the driver groups 115-10A, 115-20A, and 115-30A may be determined based on elements of a row vector, corresponding to a channel, among the row vectors of the first matrix.

The transmitter 110A may include a plurality of encoders 111-10A, 111-20A, and 111-30A, respectively corresponding to a plurality of driver groups 115-10A, 115-20A, and 115-30A. Each of the plurality of encoders 111-10A, 111-20A, and 111-30A may generate control signals U1, D1, U2, and D2 to control a driver included in a corresponding driver group based on binary bits of an input data stream. For example, the encoder 111-10A may generate control signals to control drivers, included in the first driver group 115-10, based on 3 bits of input binary data D₀<1>, D₀<2>, and D₀<3>. Similarly, the encoder 111-20A and the encoder 111-30A may generate control signals to control drivers, included in a corresponding driver group, based on bits of binary data D̅₂̅<1>, D̅₂̅<2>, D̅₂̅<3>, D̅₆̅<1>, D̅₆̅<2>, and D̅₆̅<3>, respectively.

In some example embodiments, a data stream input to each of the plurality of encoders 111-10A, 111-20A, and 111-30A may be determined based on elements of a row vector, corresponding to a channel, among the row vectors of the first matrix. For example, W_{T0} based on a first row vector of Equation 4 is 4S₀−3S₂−2S₆, so that three types of symbols S₀, −S₂, and −S₆ are required. Therefore, the data stream Do may be input to the encoder 111-10A to generate S₀, the data stream D̅₂̅ may be input to the encoder 111-20A to generate −S₂, and the data stream D̅₆̅ may be input to the encoder 111-30A to generate −S₆, as illustrated in FIG. 7A. In some example embodiments, each of the data streams Do, D̅₂̅, and D̅₆̅ may be input to a corresponding encoder in the form of 3 bits of parallel data, as illustrated in the drawing.

The 2-to-1 multiplexer 112-10A may drive PAM-3 drivers, included in the first driver group 115-10A, based on the control signals U1, D1, U2, and D2 generated in the encoder 111-10A. Accordingly, a single PAM-3 driver included in the first driver group 115-10A may generate S₀. In some example embodiments, S₀ may be a ternary symbol of 2UI. This is the same as described above with reference to FIG. 4. Since the first driver group 115-10A includes four PAM-3 drivers, the first driver group 115-10A may generate 4S₀. Similarly, the 2-to-1 multiplexers 112-20A and 112-30A may drive PAM-3 drivers, included in the second and third driver groups 115-20A and 115-30A, based on the control signals generated by the encoders 111-20A and 111-30A, respectively. Accordingly, −3S₂ and −2S₆ may be generated in the second driver group 115-20A and the third driver group 115-30A, respectively.

The ternary symbols 4S₀, −3S₂, and −2S₆ of 2UI, respectively generated in the first to third driver groups 115-10A, 115-20A, and 115-30A, may be combined to generate 4S₀-3S₂-2S₆, for example, W_{T0}.

FIG. 7B illustrates an example of a configuration of a transmitter 110B generating W_{T4}, among the output signals in Table 1. For example, W_{T4} may have a voltage level, such as −4S₃−3S₅+2S₆, based on an inner product, for example, 0·S₀+0−S₁+0·S₂−4·S₃+0·S₄−3·S₅+2·S₆, of the fifth vector [0 0 0−4 0−3 −2] of Equation 4 and a column vector S including 7 symbols S₀ to S₆.

Referring to FIG. 7B, the encoder 111-10B may generate control signals U1, D1, U2, and D2 based on the 3 bits of binary data D̅₃̅<1>, D̅₃̅<2>, and D̅₃̅<3>. The 2-to-1 multiplexer 112-10B may control the PAM-3 drivers, included in the first driver group 115-10B, based on the control signals generated by the encoder 111-10B. Accordingly, a single PAM-3 driver included in the first driver group 115-10B may generate a ternary symbol −S₃ of 2UI. Since the first driver group 115-10B includes four PAM-3 drivers, the first driver group 115-10B may generate −4S₃.

The encoder 111-20B may receive 3 bits of binary data D̅₅̅<1>, D̅₅̅<2>, and D̅₅̅<3>, and the second driver group 115-20B may include three PAM-3 drivers. Accordingly, the second driver group 115-20B may generate −3S₅.

Similarly, the encoder 111-30B may receive 3 bits of binary data D₆<1>, D₆<2>, and D₆<3>, and the third driver group 115-30B may include two PAM-3 drivers. Accordingly, the third driver group 115-30B may generate 2S₆.

The ternary symbols −4S₃, −3S₅, and 2S₆ of 2UI generated in the first to third driver groups 115-10B, 115-20B, and 115-30B are combined to generate −4S₃−3S₅+2S₆, for example, W_{T4}.

According to the example the embodiment of FIG. 7B, it can be seen that the number of drivers included in each of the driver groups 115-10B, 115-20B, and 115-30B and a data stream input to each of the plurality of encoders 111-10B, 111-20B, and 111-30B are determined based on elements of a row vector, corresponding to a channel, among row vectors of the first matrix.

FIG. 7C illustrates an example of a configuration of a transmitter related to the first row vector of the first matrix in Equation 9. Since the first row vector of the first matrix T in Equation 9 is [0 0 0 0−2 2−1], an output signal W_{T0} based on the first row vector may have the same voltage level as −2S₄+2S₅−S₆.

Referring to FIG. 7C, in relation to a −2S₄ term, the transmitter 110C may include an encoder 111-10C, to which D̅₄̅<1>, D̅₄̅<2>, and D̅₄̅<3> are input, and a first driver group 115-10C including two PAM-3 drivers.

In relation to a 2S₅ term, the transmitter 110C may include an encoder 111-20C, to which D₅<1>, D₅<2>, and D₅<3> are input, and a second driver group 115-20C including two PAM-3 driver.

In relation to a −S₆ term, the transmitter 110C may include an encoder 111-30C to which D̅₆̅<1>, D̅₆̅<2>, and D̅₆̅<3> are input, and a third driver group 115-30C including a single PAM-3 drivers.

Accordingly, the transmitter 110C may generate −2S₄+2S₅−S₆, that is, W_{T0}.

FIG. 7D illustrates an example of a configuration of a transmitter related to the third row vector of the first matrix in Equation 11. Since the third row vector of the first matrix T in Equation 11 is [0 2 0 0−1], an output signal W_{T2} based on the third row vector may have the same voltage level as 2S₁−S₄.

Accordingly, referring to FIG. 7D, in relation to a 2S₁ term, the transmitter 110D may include an encoder 111-10D, to which D₁<1>, D₁<2>, and D₁<3> are input, and a first driver group 115-10D including two PAM-3 drivers.

In relation to a −S₄ term, the transmitter 110D may include an encoder 111-20D, to which D̅₄̅<1>, D̅₄̅<2>, and D̅₄̅<3> are input, and a second driver group 115-20D including a single PAM-3 driver.

Accordingly, the transmitter 110D may generate an output signal W_{T2}, for example, 2S₁−S₄.

Various examples of how to implement a transmitter based on a first matrix have been described with reference to FIGS. 7A to 7D. In the above, various implementation examples of a transmitter based on the first matrix were described with reference to FIGS. 7A to 7D. According to the above-described example embodiments, hardware of the transmitter 110 may be configured based on the first matrix T.

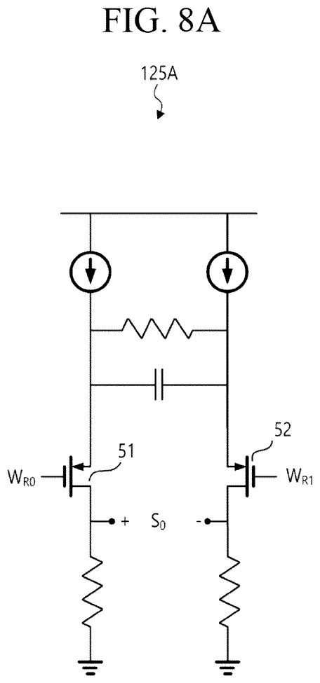

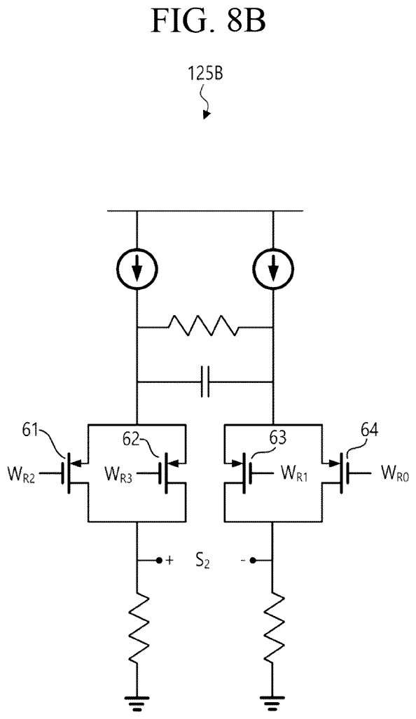

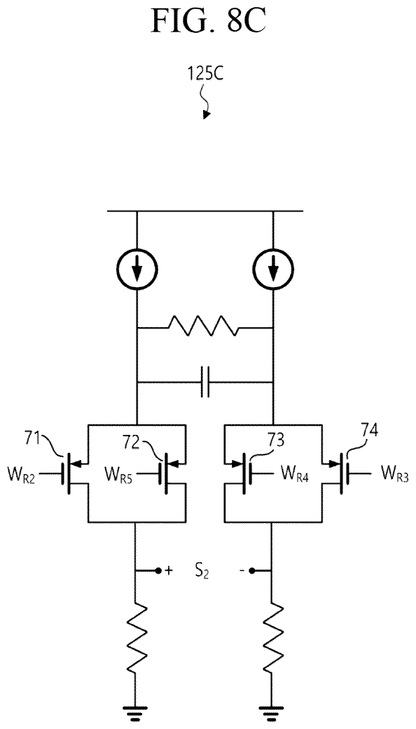

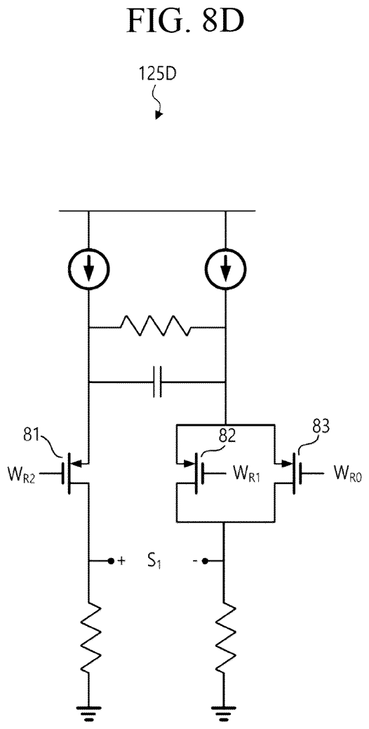

FIGS. 8A to 8D are diagrams, each illustrating a configuration of a receiver according to an example embodiment.

As described above, the receiver 120 may restore a plurality of symbols based on a plurality of received output signals. In some example embodiments, each of the plurality of symbols may be restored based on an inner product of a row vector corresponding to a symbol, among the row vectors of the second matrix, and a column vector including the plurality of received output signals.

To this end, the receiver 120 may have a configuration based on the second matrix. For example, the receiver 120 may include a combiner configured to combine at least a portion of the received output signals and perform an operation corresponding to the inner product and provided for each of the plurality of symbols. In some example embodiments, the combiner may be implemented as a differential amplifier or a continuous time linear equalizer (CTLE), but example embodiments are not limited thereto.

FIG. 8A is a diagram illustrating an example of a configuration of a combiner for restoring S₀, among the symbols in Table 2. Referring to Table 2, S₀ may be restored through an operation such as W_{R0}-W_{R1}. Accordingly, the combiner 125A for restoring S₀ may be implemented using a differential amplifier with W_{R0} and W_{R1} as inputs. For example, in a differential amplifier structure as illustrated in FIG. 8A, S₀ may be restored by connecting the received output signal W_{R0} to a gate terminal of a transistor 51 and connecting the received output signal W_{R1} to a gate terminal of a transistor 52.

FIG. 8B is a diagram illustrating an example of a configuration of a combiner for restoring S₂, among the symbols in Table 2. Referring to Table 2, S₂ may be restored through an operation such as −W_{R0}−W_{R1}+W_{R2}+W_{R3}. Accordingly, the combiner 125B for restoring S₂ may be implemented using a differential amplifier with W_{R0}, W_{R1}, W_{R2}, and W_{R3} as inputs. For example, in the differential amplifier structure as illustrated in FIG. 8B, S₂ may be restored by respectively connecting the received output signals W_{R2} and W_{R3} to gate terminals of transistor 61 and transistor 62 and respectively connecting the received output signals W_{R1} and W_{R0} to gate terminals of a transistor 63 and a transistor 64.

FIG. 8C is a diagram illustrating an example of a configuration of a combiner for restoring a symbol S₂ based on a third row vector of the second matrix in Equation 10. Referring to Equation 10, the third row vector of the second matrix R is [0 0 4−4 −4 4 0 0], so that S₂ may be restored through an operation such as 4 W_{R2}−4 W_{R3}−4 W_{R4}+4 W_{R5}. Accordingly, the combiner 125C for restoring S₂ may be implemented using a differential amplifier with W_{R2}, W_{R3}, W_{R4}, and W_{R5} as inputs. For example, in a differential amplifier structure as illustrated in FIG. 8C, S₂ may be restored by respectively connecting the received output signals W_{R2} and W_{R5} to gate terminals of a transistor 71 and a transistor 72 and respectively connecting the received output signals W_{R4} and W_{R3} to gate terminal of a transistor 73 and a transistor 74. In some example embodiments, a weight multiplied by each output signal may be easily implemented by adjusting a gain of a differential amplifier.

FIG. 8D is a diagram illustrating an example of a configuration of a combiner for restoring a symbol S₁ based on a second row vector of the second matrix in Equation 12. Referring to Equation 12, the second row vector of the second matrix R is [−1−1 2 0 0 0], so that S₁ may be restored through an operation such as −W_{R0}−W_{R1}+2 W_{R2}. Accordingly, the combiner 125D for restoring S₁ may be implemented using a differential amplifier with W_{R0}, W_{R1}, and W_{R2} as inputs. For example, in a differential amplifier structure as illustrated in FIG. 8D, S₁ may be restored by connecting the received output signal W_{R2} to a gate terminal of a transistor 81 and respectively connecting the received output signal W_{R1} and W_{R0} to gate terminals of a transistor 82 and a transistor 83. In some example embodiments, a weight multiplied by each output signal may be easily implemented by adjusting a gain of a differential amplifier.

According to the above-described example embodiments, hardware of the receiver 120 may be configured based on the second matrix R.

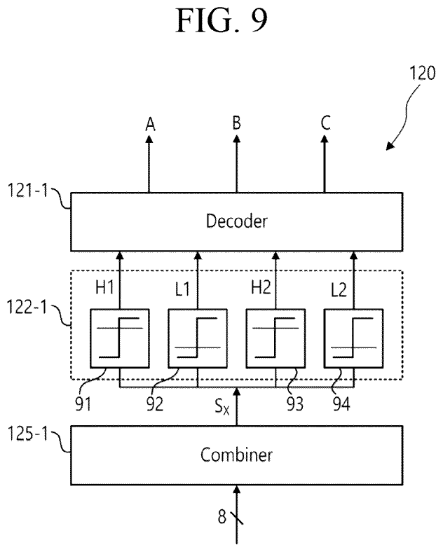

FIG. 9 is a diagram illustrating an example of a configuration of a receiver according to some example embodiments. A binary data acquisition operation of a receiver 120 will be described with reference to FIG. 9. Referring to FIG. 9, the receiver 120 may include a combiner 125-1, a sampler 122-1, and a decoder 121.

The combiner 125-1 may combine at least a portion of a plurality of received output signals to restore a symbol S_{X}. For example, when 3 bits of binary data are encoded into a ternary symbol of 2UI and then transmitted by a transmitter 110, the combiner 125-1 may combine at least a portion of the received output signals to restore the ternary symbol of 2UI. The combiner 125-1 has been described in detail with reference to FIGS. 8A to 8D, so that redundant descriptions thereof will be omitted.

The sampler 122-1 may generate a plurality of sampling signals based on a symbol level of the symbol S_{X} restored in the combiner 125-1. For example, when the ternary symbol S_{X} of 2UI is restored in the combiner 125-1, the sampler 122-1 may sample a symbol level corresponding to a first UI to generate first sampling signals H1 and L1, and may sample a symbol level corresponding to a second UI to generate second sampling signals H2 and L2.

According to some example embodiments, the sampler 122-1 may include first and second comparators 91 and 92, generating first sampling signals, and third and fourth comparators 93 and 94 generating second sampling signals.

In some example embodiments, the first comparator 91 and the third comparator 93 may have a reference voltage higher than a middle level (for example, “0”) and lower than a high level (for example, “+1”). Accordingly, the first comparator 91 and the third comparator 93 may output “1” when the symbol level is “+1”, and may output “0” when the symbol level is “0” or “−1”. The second comparator 92 and the fourth comparator 94 may have a reference voltage lower than the middle level (for example, “0”) and higher than a low level (for example, “−1”). Accordingly, the second comparator 92 and the fourth comparator 94 may output “1” when the symbol level is “+1” or “O”, and may output “O” when the symbol level is “−1”.

Accordingly, the first and second comparators 91 and 92 may respectively generate “0, 0” as the first sampling signals H1 and L1 when the symbol level corresponding to the first UI is “−1”. The first and second comparators 91 and 92 may respectively generate “0, 1” as the first sampling signals H1 and L1 when the symbol level corresponding to the first UI is “0”. The first and second comparators 91 and 92 may respectively generate “1, 1” as the first sampling signals H1 and L1 when the symbol level corresponding to the first UI is “+1”. Similarly to the first and second comparators 91 and 92, the third and fourth comparators 93 and 94 may respectively generate “0, 0” as the second sampling signals H2 and L2 when the symbol level corresponding to the second UI is “−1”, may respectively generate “0, 1” as the second sampling signals H2 and L2 when the symbol level corresponding to the second UI is “0”, and may respectively generate “1, 1” as the second sampling signals H2 and L2 when the symbol level corresponding to the second UI is “+1”.

The decoder 121-1 may obtain binary bits corresponding to the restored symbol S_{X}. For example, the decoder 121 may decode the restored symbol S_{X} based on a plurality of sampling signals generated by the sampler 122-1. For example, the decoder 121-1 may decode a plurality of sampling signals based on an inverse rule of the above-described encoding rule of the transmitter 110 to obtain binary bits corresponding to the restored symbol S_{X}.

The following Table 4 is established by summarizing the inverse rule of the encoding rule in Table 3.

TABLE 4

| H1 | L1 | H2 | L2 | ABC |
|---|---|---|---|---|
| 1 | X | 1 | X | 011 |
| 1 | X | 0 | 1 | 010 |
| 1 | X | X | 0 | 110 |
| 0 | 1 | X | 0 | 111 |
| X | 0 | X | 0 | 101 |
| X | 0 | 0 | 1 | 100 |
| X | 0 | 1 | X | 000 |
| 0 | 1 | 1 | X | 001 |

In Table 4, H1 and L1 represent first sampling signals, H2 and L2 represent second sampling signals, ABC represents binary bits, and X represents Don't care (for example, an arbitrary value). According to some example embodiments, the decoder 121-1 may obtain binary bits based on the decoding rule illustrated in Table 4.

For example, when the symbol level of the ternary symbol of the restored 2UI is “−1, −1”, the sampler 122-1 may sample a symbol level “−1” corresponding to the first UI to generate a first sampling signal “0, 0”. The sampler 122-1 may sample a symbol level “−1” corresponding to the second UI to generate a second sampling signal “0, 0”. Referring to Table 4, when H1, L1, H2, and L2 are all 0, ABC are “101”. Therefore, the decoder 121-1 may obtain “101” corresponding to the restored symbol level “−1, −1”.

For example, when the symbol level of the ternary symbol of the restored 2UI is “0, +1”, the sampler 122-1 may sample a symbol level “0” corresponding to the first UI to generate a first sampling signal “0, 1”. The sampler 122-1 may sample a symbol level “+1” corresponding to the second UI to generate a second sampling signal “1, 1”. Referring to Table 4, when H1, L1, H2, and L2 are “0, 1, 1, 1”, ABC are “001”. Therefore, the decoder 121-1 may obtain “001” corresponding to the restored symbol level “0, +1”.

It can be seen that the above decoding result exactly corresponds to the encoding rule in Table 3.

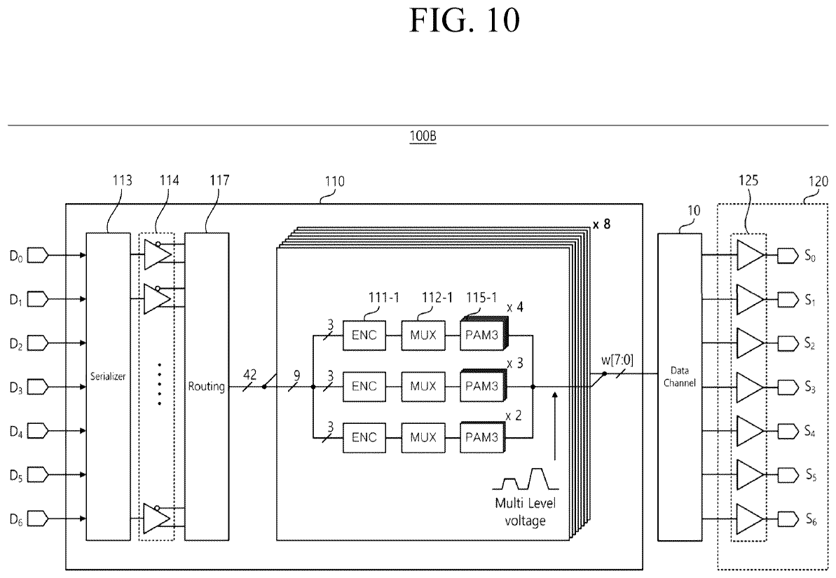

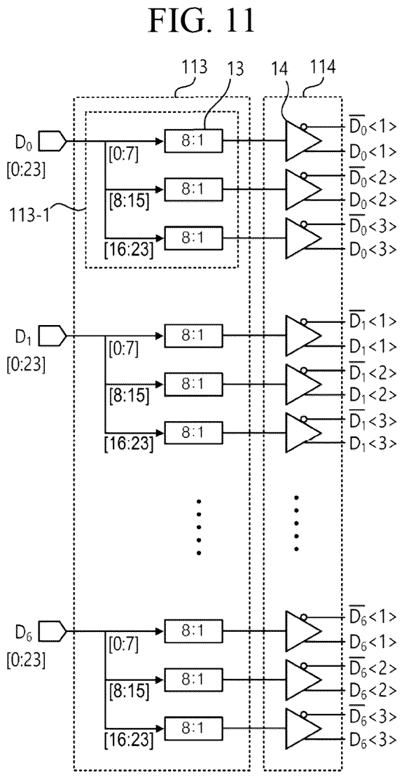

FIG. 10 is a conceptual diagram of a communication system according to some example embodiments. With respect to FIG. 10, redundant descriptions of the same configurations as described above will be omitted.

Referring to FIG. 10, a communication system 100B may include a transmitter 110 and a receiver 120.

The transmitter 110 may include a serializer 113. According to some example embodiments, the serializer 113 may convert each of a plurality of data streams Do to D₆ into three binary bit streams. For example, the serializer 113 may convert a data stream Do into three binary bit streams such as D₀<1>, D₀<2>, and D₀<3>. Similarly, the serializer 113 may convert each of a plurality of data streams D₁ to D₆ into three binary bit streams.

The predriver 114 may generate differential signals for each of the three converted binary bit streams. For example, the predriver 114 may generate D₀<1>, D̅₀̅<1>, D₀<2>, D̅₀̅<2>, D₀<3>, and D̅₀̅<3> based on D₀<1>, D₀<2>, and D₀<3> converted by the serializer 113. Similarly, the predriver 114 may generate differential signals for each binary bit stream, even for other binary bit streams.

The generated differential signals may be input to an appropriate encoder (ENC) 111-1 through routing 117. According to some example embodiments, each of the differential signals may be provided to a corresponding driver group based on the elements of the first matrix. In some example embodiments, the routing 117 may refer to wiring.

For example, as described above, according to some example embodiments, the data stream input to each of the plurality of encoders 111 may be determined based on elements of the row vector corresponding to a channel, among the row vectors of the first matrix. For example, in the example of FIG. 7A, a data stream Do may be input to the encoder 111-10A, a data stream D₂ may be input to the encoder 111-20A, and a data stream D₆ may be input to the encoder 111-30A to generate 4S₀−3S₂−2S₆. To this end, among the differential signals generated in the predriver 114, Do may be routed to the encoder 111-10A, D₂ may be routed to the encoder 111-20A, and D₆ may be routed to the encoder 111-30A.

Through the above configuration, the transmitter 110 may encode binary bits of each of the plurality of data streams D₀ to D₆ into a plurality of symbols, and may convert the plurality of symbols into a plurality of output signals (w[7:0]), respectively corresponding to the plurality of channels 10, based on the transmission rule defined by the first matrix.

The plurality of output signals w[7:0] may be received by the receiver 120 through a plurality of channels 10 (for example, a plurality of data channels).

As described above, the plurality of combiners 125 included in the receiver 120 may combine the plurality of received output signals based on the reception rule, defined by the second matrix, to restore the plurality of symbols S₀ to S₆. As described above, the symbols recovered through the plurality of combiners 125 may be decoded into binary bits through the decoders 121, respectively.

FIG. 11 is a diagram illustrating an example of how to implement a serializer and a predriver according to some example embodiments.

Referring to FIG. 11, the serializer 113 may include three 8:1 sub-serializers 13 for each of data streams Do to D₆. Accordingly, the serializer 113 may convert each of the plurality of data streams Do to D₆ into three binary bit streams. For example, three 8:1 sub-serializers 113-1 corresponding to a data stream Do may recombine 24 bits of data stream Do[0:23] by 8 bits to generate three binary bit streams. Similarly, sub-serializers corresponding to the remaining data streams D₁ to D₆ may also operate.

The predriver 114 may include a sub-predriver 14 corresponding to each sub-serializer 13. The sub-predriver 14 may generate differential signals based on binary bit streams generated by a corresponding sub-serializer 13.

An example, in which binary bits are encoded into a 3-ary symbol of 2UI, has been mainly described, but example embodiments are not limited thereto. For example, according to some example embodiments, binary bits of a data stream may be encoded into an m-ary symbol of nUI and then transmitted and received.

In some example embodiments, a driver included in each of the plurality of driver groups of the transmitter 110 may be implemented as a pulse amplitude modulation m-levels (PAM-m) driver. The PAM-m driver may generate an m-ary symbol of nUI corresponding to x binary bits based on control signals generated by the encoder 111. In some example embodiments, x may be a maximum integer less than n·log₂ m.

For example, when m is 3 and n is 2, x is 3, a largest integer less than 2·log₂ 3. Accordingly, the PAM-3 driver may generate a 3-ary symbol of 2UI corresponding to 3 binary bits. For example, when m is 3 and n is 3, x is 4, the largest integer less than 3·log₂ 3. Accordingly, the PAM-3 driver may generate a 3-ary symbol of 3UI corresponding to 4 binary bits.

In some example embodiments, combinations of x binary bits may be mapped to a constellation diagram, including n axes, to satisfy the following two conditions. Each of the n axes may represent a symbol level of a corresponding UI. For example, among the n axes, a first axis may represent a first symbol level of first UI, a second axis may represent a second symbol level of second UI, and an n-th axis may represent an n-th symbol level of n-th UI. Each of the first to n-th symbol levels on the constellation diagram may have m levels.

First Condition: 2^{x} combinations of x binary bits are mapped to 2^{x} points, among mⁿ points of the constellation diagram. In some example embodiments, for any element in a set S that is a set of the mapped points, the number of other elements in the set whose Euclidean distance to a corresponding element is 1 is at most 2.

Second Condition: a Hamming distance between combinations mapped to adjacent points, among the 2^{x} combinations mapped based on First Condition, in the constellation diagram is 1.

Accordingly, even when x binary bits are encoded into an m-ary symbol of nUI, bit errors caused by AWGN may be reduced (and/or minimized).

The encoding rule described above in FIG. 6 may be an example in which n is 2 and m is 3 in the above encoding rule.

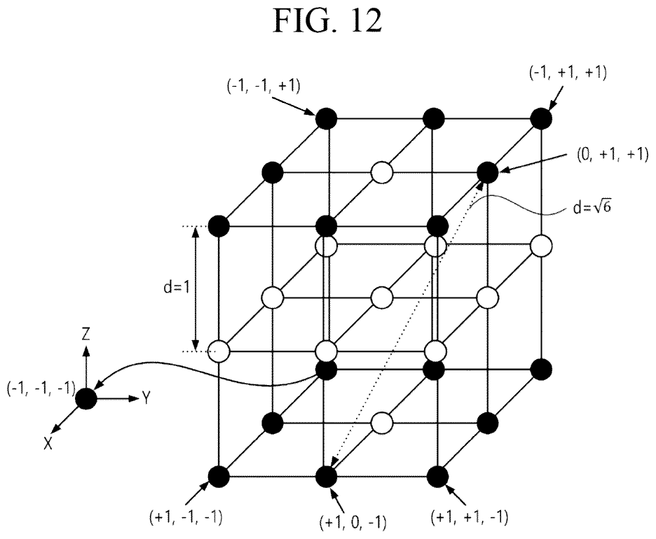

FIG. 12 is a constellation diagram illustrating an encoding rule by which 4 binary bits are encoded into a 3-ary symbol of 3 UI based on the above encoding rule. In the constellation diagram, an X-axis, a Y-axis, and a Z-axis of the constellation diagram represent a first symbol level of first UI, a second symbol level of second UI, and a third symbol level of third UI, respectively. Each symbol level may have three levels (−1, 0, 1), “d” represents a Euclidean distance between points in the constellation diagram.

Referring to FIG. 12, 16 combinations of 4 binary bits may be mapped to 16 (=2⁴) points indicated by black dots, among the 27 (=3³) points in the constellation diagram. It can be seen that for each of the 16 points, the number of other mapped points whose Euclidean distance to a corresponding element is 2, which is less than or equal to 2. Combinations whose Hamming distance is 1, among the 16 combinations of 4 binary bits, may be mapped to adjacent points among the 16 points (for example, points whose Euclidean distance is 1), respectively.

An example, in which 7 data streams are driven on 8 wires (for example, 8 channels), has been mainly described, but example embodiments are limited thereto. As described in Equations 11 and 12, an example in which 5 parallel data streams are driven on 6 wires (for example, 6 channels) may be provided. An example in which m parallel data streams are driven on n channels may also be provided. In some example embodiments, n may be an integer larger than m.

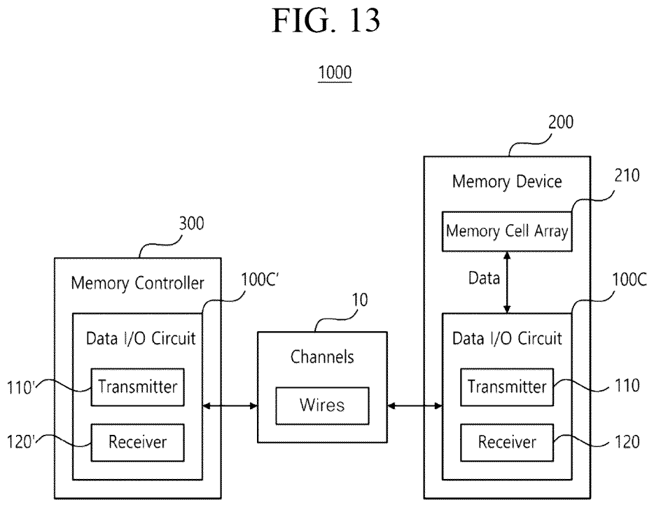

FIG. 13 is a block diagram of a memory system according to an example embodiment. An example of how to implement a communication system according to some example embodiments will be described with reference to FIG. 13.

Referring to FIG. 13, a memory system 1000 may include a memory device 200 and a memory controller 300. The memory device 200 and the memory controller 300 may be connected through a plurality of channels 10 to transmit and receive signals to and from each other. According to some example embodiments, the plurality of channels 10 may be a memory interface.

The memory device 200 may include a memory cell array 210 and a data input/output (I/O) circuit 100C. The memory cell array 210 may include a plurality of memory cells connected to a plurality of rows and a plurality of columns. The data I/O circuit 100C may store data, transmitted from an external entity (for example, the memory controller 300, or the like) of the memory device 200, in the memory cell array 210 or may output data, stored in the memory cell array 210, to an external entity of the memory device 200.

According to some example embodiments, the data I/O circuit 100C may include the above-described communication system 100. The data I/O circuit 100C may be a type of transceiver. For example, the data I/O circuit 100C may include a transmitter 110 and a receiver 120.

The transmitter 110 may receive data from the memory cell array 210, and may generate a plurality of output signals based on the received data.

For example, the transmitter 110 may receive a plurality of data streams in parallel from the memory cell array 210. Accordingly, the transmitter 110 may encode binary bits of each of the plurality of data streams into a plurality of symbols, and may generate a plurality of output signals based on a transmission rule defined by a first matrix. In some example embodiments, each of the plurality of output signals may have a voltage level based on an inner product of a row vector corresponding to a channel, among row vectors of the first matrix, and the column vector including a plurality of symbols.

To this end, the transmitter 110 may include a plurality of driver groups, configured to perform an operation corresponding to the inner product, for each of a plurality of channels. For example, the transmitter 110 may include a plurality of encoders 111, respectively corresponding to the plurality of driver groups. Each of the plurality of encoders 111 may generate control signals for controlling at least one driver, included in a corresponding driver group, based on binary bits of an input data stream. According to an some example embodiments, each of the plurality of encoders 111 may generate control signals based on an encoding rule defined to reduce (and/or minimize) decoding errors caused by additive white Gaussian noise (AWGN). Accordingly, each of the at least one driver, included in a corresponding driver group, may generate a symbol level of a symbol corresponding to binary bits of an input data stream based on the control signals.

In some example embodiments, the number of drivers included in each of the plurality of driver groups and a data stream input to each of the plurality of encoders may be determined based on the elements of a row vector corresponding to a channel, among row vectors of the first matrix.

The receiver 120 may receive output signals provided from the memory controller 300, and may obtain binary bit data based on the received output signals. The receiver 120 may store the generated binary bit data in the memory cell array 210. Since the receiver 120 of the memory device 200 is substantially the same as a receiver 120′ of the memory controller 300, the following description of the receiver 120′ of the memory controller 300 will be referred to.

The memory controller 300 may provide signals to the memory device 200 to control an operation of the memory device 200. According to some example embodiments, the memory controller 300 may provide a command CMD and an address ADDR to the memory device 200 to access the memory cell array 210 and to control memory operations such as a read operation, a write operation, or the like. Data may be transmitted from the memory cell array 210 to the memory controller 300 according to a read operation, and data may be transmitted from the memory controller 300 to the memory cell array 210 according to a write operation.

According to an example embodiment, the memory controller 300 may access the memory device 200 based on a request from a host outside the memory system 1000. The memory controller 300 may communicate with the host using various protocols.

A data I/O circuit 100C′ of the memory controller 300 may output data to the memory device 200 or receive data output from the memory device 200. According to an example embodiment, the data I/O circuit 100C′ may include the above-described communication system 100. For example, the data I/O circuit 100C′ may include a transmitter 110′ and a receiver 120′.

The transmitter 110′ may transmit data, provided from an external host, to the memory device 200. Since the transmitter 110′ of the memory controller 300 is substantially the same as the transmitter 110 of the memory device 200, the above description of the transmitter 110 of the memory device 200 will be referred to.

The receiver 120′ may receive a plurality of output signals transmitted through a plurality of channels 10. Accordingly, the receiver 120′ may combine the plurality of received output signals based on a reception rule, defined by a second matrix, to restore a plurality of symbols and may decode the restored plurality of symbols into binary bits. In some example embodiments, each of the plurality of symbols may be restored based on an inner product of a row vector corresponding to a symbol, among row vectors of the second matrix, and a column vector including the plurality of received output signals.

For example, the receiver 120′ may include a plurality of combiners 125 configured to perform an operation corresponding to the inner product. The plurality of combiners 125 may combine the plurality of received output signals based on the reception rule, defined by the second matrix, to restore the plurality of symbols. In some example embodiments, an output signal input to each of the plurality of combiners 125 may be determined based on elements of the row vector corresponding to a symbol, among the row vectors of the second matrix.

The receiver 120′ may include a plurality of decoders 121. The plurality of decoders 121 may decode each of the plurality of symbols, restored by the plurality of combiners 125, into binary bits. For example, the plurality of decoders 121 may obtain binary bits corresponding to the restored symbol based on a plurality of sampling signals obtained by sampling a symbol level of the restored symbol. In some example embodiments, the plurality of decoders 121 may use an inverse rule of an encoding rule of the transmitters 110 and 110′ (for example, the encoding rule defined to reduce (and/or minimize) decoding errors caused by AWGN)

The receiver 120′ may directly use the obtained binary data, or may provide the obtained binary data to the host.

The memory device 200 may be a storage device based on a semiconductor device. According to some example embodiments, the memory device 200 may include dynamic random access memory (DRAM) device or flash memory devices. Alternatively, the memory device 200 may include another volatile or nonvolatile memory device in which the transmitter 110 and/or the receiver 120 are used.

According to the above-described various example embodiments, when data is transmitted and received using a plurality of channels, a crosstalk effect between adjacent channels may be reduced (and/or minimized). An issue of signal deterioration, caused by SSN during massive parallel data transmission, may be addressed. A higher data transmission rate may be achieved. Decoding errors caused by AWGN may be reduced (and/or minimized). When the various embodiments are used in a next-generation high bandwidth memory (HBM) interface, energy efficiency of less than 0.6 pJ/bit may be secured at channel loss of less than 11 dB.

Each of elements (e.g., module or program) according to various example embodiments may be configured with a single entity or a plurality of entities. Some of the above-described sub-elements may be omitted, and/or other sub-elements may be further included in various embodiments. Alternatively or additionally, some elements (e.g., modules or programs) may be integrated into one entity, and may perform a function, performed by each corresponding element prior to the integration, identically or similarly. Operations performed by a module, a program or other elements according to various example embodiments may be executed sequentially, in parallel, repeatedly, or heuristically, or at least some operations may be executed in different order or may be omitted, or other operations may be added.

As set forth above, when data is transmitted and received using a plurality of channels, crosstalk between adjacent channels may be reduced (and/or minimized), simultaneous switching noise (SSN) may be reduced and/or limited, and a higher data transmission rate may be achieved.

One or more of the elements disclosed above may include or be implemented in processing circuitry such as hardware including logic circuits; a hardware/software combination such as a processor executing software; or a combination thereof. For example, the processing circuitry more specifically may include, but is not limited to, a central processing unit (CPU), an arithmetic logic unit (ALU), a digital signal processor, a microcomputer, a field programmable gate array (FPGA), a System-on-Chip (SoC), a programmable logic unit, a microprocessor, application-specific integrated circuit (ASIC), etc.

While example embodiments have been shown and described above, it will be apparent to those skilled in the art that modifications and variations could be made without departing from the scope of the inventive concepts as defined by the appended claims.

What is claimed is:

1. A communication system comprising:
a transmitter configured to encode binary bits of each of a plurality of data streams into a plurality of symbols and to convert the plurality of symbols into a plurality of output signals, respectively corresponding to a plurality of channels, the converting based on a transmission rule that is defined by a first matrix; and
a receiver configured to combine the plurality of output signals, received through the plurality of channels, the combining based on a reception rule defined by a second matrix, the combining restoring the plurality of symbols, and the receiver configured to decode the plurality of symbols into the binary bits,
wherein the first matrix and the second matrix are determined based on a third matrix that models a crosstalk effect between adjacent channels from among the plurality of channels, to reduce the crosstalk effect.

2. The communication system of claim 1, wherein
in response to the number of the plurality of data streams being m and the number of the plurality of channels being n, the first matrix and the second matrix are determined based on the following equation:
$$arg {min}_{T , R} max ( abs ( ( {R}_{eff} \cdot C \cdot {T}_{eff} - diag ( {R}_{eff} \cdot C \cdot {T}_{eff} ) ) \times [ \begin{matrix}1 \\ ⋮ \\ 1\end{matrix} ] ) ) ,$$
where T_{eff} is
$$diag ( \frac{1}{{t}_{1}} , \frac{1}{{t}_{2}} , … , \frac{1}{{t}_{n}} ) \cdot T , {R}_{eff}$$
is diag(g₁, g₂, . . . , gₘ)·R, T is the first matrix, R is the second matrix, C is the third matrix obtained by modeling the crosstalk effect between the plurality of channels, and tᵢ is an L1 norm of an i-th row vector of T.

3. The communication system of claim 2, wherein
a product matrix of R_{eff} and T_{eff} is an m-order equivalent matrix,
T is an n×m integer matrix,
a sum of elements of a column vector of T is 0,
the L1 norm of a row vector of T is less than or equal to a threshold value, and
R is an m×n integer matrix.

4. The communication system of claim 1, wherein
row vectors of the first matrix correspond to the plurality of channels, respectively, and
each of the plurality of output signals has a voltage level based on an inner product of a row vector corresponding to a channel from among the row vectors of the first matrix, and a column vector comprising the plurality of symbols.

5. The communication system of claim 4, wherein
the transmitter comprises a plurality of driver groups that are configured to perform an operation corresponding to the inner product, for each of the plurality of channels, and
a number of drivers included in each of the plurality of driver groups is determined based on elements of a row vector corresponding to a channel from among the row vectors of the first matrix.

6. The communication system of claim 5, wherein
the transmitter comprises a plurality of encoders, respectively corresponding to the plurality of driver groups,
each of the plurality of encoders is configured to generate control signals for controlling at least one driver included in a corresponding driver group, based on binary bits of an input data stream,
each of the at least one driver included in the corresponding driver group is configured to generate a symbol level of a symbol corresponding to the binary bits of the input data stream based on the control signals, and
a data stream, input to each of the plurality of encoders, is determined based on elements of a row vector corresponding to a channel among the row vectors of the first matrix.

7. The communication system of claim 6, wherein
each of the plurality of encoders is configured to generate the control signals based on an encoding rule defined to reduce decoding errors caused by additive white Gaussian noise (AWGN).

8. The communication system of claim 7, wherein
a driver, included in each of the plurality of driver groups, is a pulse amplitude modulation three level (PAM-3) driver, and
the PAM-3 driver is configured to generate a ternary symbol of 2 unit intervals (UI) corresponding to three binary bits based on the control signals.

9. The communication system of claim 8, wherein
the ternary symbol of 2UI comprises a first symbol level of a first UI and a second symbol level of a second UI,
each of the first and second symbol levels is a single level, among a low level, a middle level, and a high level, and
the encoding rule, expressed as a constellation diagram in which a horizontal axis is the first symbol level and a vertical axis is the second symbol level, satisfies the following first and second conditions:
the first condition: eight combinations of three binary bits are mapped to eight points, other than a point at which both the first symbol level and the second symbol level are middle levels, among nine points in the constellation diagram; and
the second condition: a Hamming distance between combinations mapped to adjacent points of the constellation diagram, among the eight combinations mapped based on the first condition, is 1.

10. The communication system of claim 5, wherein
a voltage level of each of the plurality of output signals has a value normalized between a driving voltage of a driver, included in each of the plurality of driver groups, and a ground voltage.

11. The communication system of claim 8, wherein
the transmitter comprises:
a serializer configured to convert each of the plurality of data streams into three binary bit streams; and
a predriver configured to generate differential signals for each of the three converted binary bit streams, and
each of the differential signals is provided to a corresponding driver group based on elements of the first matrix.

12. The communication system of claim 1, wherein
a sum of voltage levels of the plurality of output signals remains constant over time.

13. The communication system of claim 1, wherein
row vectors of the second matrix correspond to the plurality of symbols, respectively, and
each of the plurality of symbols is restored based on an inner product of a row vector corresponding to a symbol from among the row vectors of the second matrix, and a column vector comprising the received plurality of output signals.

14. The communication system of claim 13, wherein
the receiver comprises a combiner configured to combine at least a portion of the plurality of received output signals, the combiner configured to perform an operation corresponding to the inner product, for each of the plurality of symbols, and
an output signal, input to the combiner, is determined based on elements of a row vector corresponding to a symbol from among the row vectors of the second matrix.

15. The communication system of claim 14, wherein
the receiver comprises a sampler and a decoder corresponding to the combiner,
the sampler is configured to generate a plurality of sampling signals based on a symbol level of a symbol restored in the combiner, and
the decoder is configured to obtain binary bits, corresponding to the restored symbol, based on the plurality of sampling signals.

16. The communication system of claim 15, wherein
the transmitter is configured to encode binary bits into a symbol based on an encoding rule defined to reduce error bits caused by additive white Gaussian noise (AWGN), and
the decoder is configured to obtain binary bits, corresponding to the restored symbol, based on an inverse rule of the encoding rule.

17. The communication system of claim 16, wherein
each of the plurality of symbols is a ternary symbol of 2 unit intervals (UI),
the sampler is configured to generate the plurality of sampling signals based on symbol levels of a ternary symbol of 2UI restored in the combiner, and
the decoder is configured to obtain three binary bits corresponding to the ternary symbol of 2UI based on the plurality of sampling signals.

18. The communication system of claim 1, wherein
the transmitter and the receiver are included in a single transceiver.

19. A transmitter comprising:
a plurality of encoders each configured to generate control signals for converting binary data of input data streams from among n data streams into symbol data; and
a plurality of drivers configured to generate the symbol data based on the control signals, the plurality of drivers configured to transmit an output signal based on the generated symbol data through n+1 channels, based on a transmission rule defined by an encoding matrix,
wherein
the encoding matrix is an (n+1)×n-dimensional matrix determined based on a matrix that models a crosstalk effect between adjacent channels of the n+1 channels, to reduce the crosstalk effect, and
each of the plurality of encoders is configured to generate the control signals based on an encoding rule defined to reduce decoding errors caused by additive white Gaussian noise (AWGN).

20. A receiver comprising:
a plurality of combiners configured to combine n+1 output signals received through n+1 channels based on a reception rule defined by a decoding matrix, and the plurality of combiners configured to restore n symbols from the combined n+1 output signals; and
a plurality of decoders configured to obtain n pieces of binary data based on the restored n symbols,
wherein
the decoding matrix is an n×(n+1)-dimensional matrix determined based on a matrix that models a crosstalk effect between adjacent channels of the n+1 channels, to reduce crosstalk effect, and
each of the plurality of decoders is configured to obtain the binary data based on an inverse rule of an encoding rule defined to reduce decoding errors caused by additive white Gaussian noise (AWGN).
